(19) United States
(12) Patent Application Publication
(10) Pub. No.: US 2024/0105187 A1
(43) Pub. Date: Mar. 28, 2024

(54) THREE-DIMENSIONAL AUDIO SIGNAL PROCESSING METHOD AND APPARATUS

(71) Applicant: HUAWEI TECHNOLOGIES CO., LTD., Shenzhen (CN)

(72) Inventors: Yuan GAO, Beijing (CN); Shuai LIU, Beijing (CN); Bin WANG, Shenzhen (CN); Zhe WANG, Beijing (CN); Tianshu QU, Beijing (CN); Jiahao XU, Beijing (CN)

(21) Appl. No.: 18/521,944

(22) Filed: Nov. 28, 2023

Related U.S. Application Data
(63) Continuation of application No. PCT/CN2022/096025, filed on May 30, 2022.

(30) Foreign Application Priority Data
May 31, 2021 (CN) 202110602507.4

(51) Int. Cl. G10L 19/008; G10L 19/02; H04S 7/00

(52) U.S. Cl. CPC G10L 19/008; G10L 19/02; H04S 7/30; H04S 2420/11

(57) ABSTRACT

Embodiments of this application disclose a three-dimensional audio signal processing method and apparatus, to implement sound field classification of a three-dimensional audio signal, to accurately identify the three-dimensional audio signal. An embodiment of this application provides a three-dimensional audio signal processing method, including: performing linear decomposition on a current frame of a three-dimensional audio signal, to obtain a linear decomposition result; obtaining, based on the linear decomposition result, a sound field classification parameter corresponding to the current frame; and determining a sound field classification result of the current frame based on the sound field classification parameter.

### CROSS-REFERENCE TO RELATED APPLICATIONS

This application is a continuation of International Application No. PCT/CN2022/096025, filed on May 30, 2022, which claims priority to Chinese Patent Application No. 202110602507.4, filed on May 31, 2021. The disclosures of the aforementioned applications are hereby incorporated by reference in their entireties.

### TECHNICAL FIELD

This application relates to the field of audio processing technologies, and in particular, to a three-dimensional audio signal processing method and apparatus.

### BACKGROUND

A three-dimensional audio technology is widely used in wireless communication speech, virtual reality/augmented reality, media audio, and the like. The three-dimensional audio technology is an audio technology for obtaining, processing, transmitting, rendering, and playing back a sound event and three-dimensional sound field information in the real world. The three-dimensional audio technology makes sound have strong senses of space, envelopment, and immersion, and provides extraordinary “immersed” auditory experience. A higher-order ambisonics (HOA) technology is independent of speaker layout during recording, encoding and playback, and has a feature of rotatable playback of data in an HOA format. The higher-order ambisonics technology has higher flexibility in three-dimensional audio playback, and therefore is much concerned and researched.

A capturing device (for example, a microphone) captures a large amount of data to record three-dimensional sound field information, and transmits a three-dimensional audio signal to a playback device (for example, a speaker or an earphone), so that the playback device plays the three-dimensional audio signal. Because a data amount of the three-dimensional sound field information is large, a large amount of storage space is required to store the data, and a high bandwidth is required for transmitting the three-dimensional audio signal. To resolve the foregoing problem, the three-dimensional audio signal may be compressed, and compressed data may be stored or transmitted.

Currently, an encoder may encode the three-dimensional audio signal by using a plurality of preconfigured virtual speakers. However, before encoding the three-dimensional audio signal, the encoder cannot classify the three-dimensional audio signal, and consequently the three-dimensional audio signal cannot be effectively identified.

### SUMMARY

Embodiments of this application provide a three-dimensional audio signal processing method and apparatus, to implement sound field classification of a three-dimensional audio signal, to accurately identify the three-dimensional audio signal.

To resolve the foregoing technical problem, embodiments of this application provide the following technical solutions.

According to a first aspect, an embodiment of this application provides a three-dimensional audio signal processing method, including: performing linear decomposition on a current frame of a three-dimensional audio signal, to obtain a linear decomposition result; obtaining, based on the linear decomposition result, a sound field classification parameter corresponding to the current frame; and determining a sound field classification result of the current frame based on the sound field classification parameter. In the foregoing solutions, linear decomposition is first performed on the current frame of the three-dimensional audio signal, to obtain the linear decomposition result. Then, the sound field classification parameter corresponding to the current frame is obtained based on the linear decomposition result. Finally, the sound field classification result of the current frame is determined based on the sound field classification parameter. In this embodiment of this application, linear decomposition is performed on the current frame of the three-dimensional audio signal, to obtain the linear decomposition result of the current frame. Then, the sound field classification parameter corresponding to the current frame is obtained based on the linear decomposition result. Therefore, the sound field classification result of the current frame is determined based on the sound field classification parameter, and sound field classification of the current frame can be implemented based on the sound field classification result. In this embodiment of this application, sound field classification is performed on the three-dimensional audio signal, to accurately identify the three-dimensional audio signal.

In one embodiment, the three-dimensional audio signal includes a higher-order ambisonics HOA signal or a first-order ambisonics FOA signal.

In one embodiment, the performing linear decomposition on a current frame of a three-dimensional audio signal, to obtain a linear decomposition result includes: performing singular value decomposition on the current frame, to obtain a singular value corresponding to the current frame, where the linear decomposition result includes the singular value; performing principal component analysis on the current frame, to obtain a first feature value corresponding to the current frame, where the linear decomposition result includes the first feature value; or performing independent component analysis on the current frame, to obtain a second feature value corresponding to the current frame, where the linear decomposition result includes the second feature value. In the foregoing solutions, linear decomposition may be singular value decomposition. Linear decomposition may alternatively be principal component analysis, to obtain the feature value, or linear decomposition may alternatively be independent component analysis, to obtain the second feature value. In any one of the three manners, linear decomposition of the current frame may be implemented, to provide a linear analysis result for subsequent audio channel determining.

In one embodiment, there are a plurality of linear decomposition results, and there are a plurality of sound field classification parameters. The obtaining, based on the linear decomposition result, a sound field classification parameter corresponding to the current frame includes: obtaining a ratio of an i^{th} linear analysis result of the current frame to an (i+1)^{th} linear analysis result of the current frame, where i is a positive integer; and obtaining, based on the ratio, an i^{th} sound field classification parameter corresponding to the current frame.

Further, the i^{th} linear analysis result and the (i+1)^{th} linear analysis result are two consecutive linear analysis results of the current frame.

In the foregoing solutions, an encoder side may obtain, based on the linear decomposition result, the sound field classification parameter corresponding to the current frame. For example, there are a plurality of linear decomposition results of the current frame, and two consecutive linear analysis results in the plurality of linear analysis results are represented as the i^{th} linear analysis result and the (i+1)^{th} linear analysis result of the current frame. In this case, the ratio of the i^{th} linear analysis result of the current frame to the (i+i)^{th} linear analysis result of the current frame may be calculated, and a specific value of i is not limited. After the ratio is obtained, the i^{th} sound field classification parameter corresponding to the current frame may be obtained based on the ratio of the i^{th} linear analysis result to the (i+1)^{th} linear analysis result of the current frame.

In one embodiment, there are a plurality of sound field classification parameters, and the sound field classification result includes a sound field type. The determining a sound field classification result of the current frame based on the sound field classification parameter includes: when values of the plurality of sound field classification parameters all meet a preset dispersive sound source decision condition, determining that the sound field type is a dispersive sound field; or when at least one of values of the plurality of sound field classification parameters meets a preset heterogeneous sound source decision condition, determining that the sound field type is a heterogeneous sound field. In the foregoing solutions, the sound field type may include a heterogeneous sound field and a dispersive sound field. In this embodiment of this application, the dispersive sound source decision condition and the heterogeneous sound source decision condition are preset. The dispersive sound source decision condition is used to determine whether the sound field type is a dispersive sound field, and the heterogeneous sound source decision condition is used to determine whether the sound field type is a heterogeneous sound field. After the plurality of sound field classification parameters of the current frame are obtained, determining is performed based on the values of the plurality of sound field classification parameters and the preset condition.

In one embodiment, the dispersive sound source decision condition includes that the value of the sound field classification parameter is less than a preset heterogeneous sound source determining threshold; or the heterogeneous sound source decision condition includes that the value of the sound field classification parameter is greater than or equal to a preset heterogeneous sound source determining threshold. In the foregoing solutions, the heterogeneous sound source determining threshold may be a preset threshold, and a specific value is not limited. The dispersive sound source decision condition includes that the value of the sound field classification parameter is less than the preset heterogeneous sound source determining threshold. Therefore, when the values of the plurality of sound field classification parameters are all less than the preset heterogeneous sound source determining threshold, it is determined that the sound field type is the dispersive sound field. The heterogeneous sound source decision condition includes that the value of the sound field classification parameter is greater than or equal to the preset heterogeneous sound source determining threshold. Therefore, when at least one of the values of the plurality of sound field classification parameters is greater than or equal to the preset heterogeneous sound source determining threshold, it is determined that the sound field type is the heterogeneous sound field.

In one embodiment, there are a plurality of sound field classification parameters, and the sound field classification result includes a sound field type, or the sound field classification result includes a quantity of heterogeneous sound sources and a sound field type. The determining a sound field classification result of the current frame based on the sound field classification parameter includes: obtaining, based on values of the plurality of sound field classification parameters, the quantity of heterogeneous sound sources corresponding to the current frame; and determining the sound field type based on the quantity of heterogeneous sound sources corresponding to the current frame. In the foregoing solutions, after obtaining the plurality of sound field classification parameters corresponding to the current frame, the encoder side may obtain, based on the values of the plurality of sound field classification parameters, the quantity of heterogeneous sound sources corresponding to the current frame. The heterogeneous sound sources are point sound sources with different positions and/or directions, and the quantity of heterogeneous sound sources included in the current frame is referred to as a quantity of heterogeneous sound sources. A sound field of the current frame can be classified based on the quantity of heterogeneous sound sources. After the quantity of heterogeneous sound sources corresponding to the current frame is obtained to determine the sound field type, the sound field type corresponding to the current frame may be determined by analyzing the quantity of heterogeneous sound sources corresponding to the current frame.

In one embodiment, there are a plurality of sound field classification parameters, and the sound field classification result includes a quantity of heterogeneous sound sources. The determining a sound field classification result of the current frame based on the sound field classification parameter includes: obtaining, based on values of the plurality of sound field classification parameters, the quantity of heterogeneous sound sources corresponding to the current frame. In the foregoing solutions, after obtaining the plurality of sound field classification parameters corresponding to the current frame, the encoder side may obtain, based on the values of the plurality of sound field classification parameters, the quantity of heterogeneous sound sources corresponding to the current frame. The heterogeneous sound sources are point sound sources with different positions and/or directions, and the quantity of heterogeneous sound sources included in the current frame is referred to as a quantity of heterogeneous sound sources.

In one embodiment, the plurality of sound field classification parameters are temp[i], i=0, 1, . . . , min(L, K)−2, L indicates a quantity of channels of the current frame, K is a quantity of signal points corresponding to each channel of the current frame, and min indicates an operation in which a minimum value is selected. The obtaining, based on values of the plurality of sound field classification parameters, a quantity of heterogeneous sound sources corresponding to the current frame includes: sequentially performing the following determining procedures from i=0: determining whether temp[i] is greater than a preset heterogeneous sound source determining threshold; and when temp[i] is less than the heterogeneous sound source determining threshold in this determining procedure, updating a value of i to i+1, and continuing to perform a next determining procedure; or when temp[i] is greater than or equal to the heterogeneous sound source determining threshold in this determining procedure, terminating execution of the determining procedure, and determining that i in this determining procedure plus 1 is equal to the quantity of heterogeneous sound sources. In the foregoing solutions, the determining procedure is performed for a plurality of times, and whether to terminate execution of the determining procedure is determined each time, to obtain the quantity of heterogeneous sound sources.

In one embodiment, the determining the sound field type based on the quantity of heterogeneous sound sources corresponding to the current frame includes: when the quantity of heterogeneous sound sources meets a first preset condition, determining that the sound field type is a first sound field type; or when the quantity of heterogeneous sound sources does not meet a first preset condition; determining that the sound field type is a second sound field type. A quantity of heterogeneous sound sources corresponding to the first sound field type is different from a quantity of heterogeneous sound sources corresponding to the second sound field type. In the foregoing solutions, sound field types may be classified into two types based on different quantities of heterogeneous sound sources: the first sound field type and the second sound field type. The encoder side obtains the preset condition; determines whether the quantity of heterogeneous sound sources meets the preset condition; and when the quantity of heterogeneous sound sources meets the first preset condition, determines that the sound field type is the first sound field type; or when the quantity of heterogeneous sound sources does not meet the first preset condition, determines that the sound field type is the second sound field type. In this embodiment of this application, whether the quantity of heterogeneous sound sources meets the first preset condition may be determined, to implement division of the sound field type of the current frame, to accurately identify that the sound field type of the current frame belongs to the first sound field type or the second sound field type.

In one embodiment, the first preset condition includes that the quantity of heterogeneous sound sources is greater than a first threshold and less than a second threshold, and the second threshold is greater than the first threshold; or the first preset condition includes that the quantity of heterogeneous sound sources is not greater than a first threshold or not less than a second threshold, and the second threshold is greater than the first threshold. In the foregoing solutions, specific values of the first threshold and the second threshold are not limited, and may be specifically determined based on an application scenario. The second threshold is greater than the first threshold. Therefore, the first threshold and the second threshold may form a preset range, and the first preset condition may be that the quantity of heterogeneous sound sources falls within the preset range, or the first preset condition may be that the quantity of heterogeneous sound sources is beyond the preset range. The quantity of heterogeneous sound sources may be determined based on the first threshold and the second threshold in the first preset condition, to determine whether the quantity of heterogeneous sound sources meets the first preset condition, to accurately identify that the sound field type of the current frame belongs to the first sound field type or the second sound field type.

In one embodiment, the method further includes: determining, based on the sound field classification result, an encoding mode corresponding to the current frame. In the foregoing solutions, the encoder side may determine, based on the sound field classification result, the encoding mode corresponding to the current frame. The encoding mode is a mode used when the current frame of the three-dimensional audio signal is encoded. There are a plurality of encoding modes, and different encoding modes may be used based on different sound field classification results of the current frame. In this embodiment of this application, appropriate encoding modes are selected for different sound field classification results of the current frame, so that the current frame is encoded by using the encoding mode. This improves compression efficiency and auditory quality of an audio signal.

In one embodiment, the determining, based on the sound field classification result, an encoding mode corresponding to the current frame includes: when the sound field classification result includes the quantity of heterogeneous sound sources, or the sound field classification result includes the quantity of heterogeneous sound sources and the sound field type, determining, based on the quantity of heterogeneous sound sources, the encoding mode corresponding to the current frame; when the sound field classification result includes the sound field type, or the sound field classification result includes the quantity of heterogeneous sound sources and the sound field type, determining, based on the sound field type, the encoding mode corresponding to the current frame; or when the sound field classification result includes the quantity of heterogeneous sound sources and the sound field type, determining, based on the quantity of heterogeneous sound sources and the sound field type, the encoding mode corresponding to the current frame. In the foregoing solutions, the encoder side may determine, based on the quantity of heterogeneous sound sources and/or the sound field type, the encoding mode corresponding to the current frame, to determine a corresponding encoding mode based on the sound field classification result of the current frame, so that the determined encoding mode can be adapted to the current frame of the three-dimensional audio signal. This improves encoding efficiency.

In one embodiment, the determining, based on the quantity of heterogeneous sound sources, the encoding mode corresponding to the current frame includes: when the quantity of heterogeneous sound sources meets a second preset condition, determining that the encoding mode is a first encoding mode; or when the quantity of heterogeneous sound sources does not meet a second preset condition, determining that the encoding mode is a second encoding mode. The first encoding mode is an HOA encoding mode based on virtual speaker selection or an HOA encoding mode based on directional audio coding, the second encoding mode is an HOA encoding mode based on virtual speaker selection or an HOA encoding mode based on directional audio coding, and the first encoding mode and the second encoding mode are different encoding modes. In the foregoing solutions, encoding modes may be classified into two types based on different quantities of heterogeneous sound sources: the first encoding mode and the second encoding mode. The encoder side obtains the second preset condition; determines whether the quantity of heterogeneous sound sources meets the second preset condition; and when the quantity of heterogeneous sound sources meets the second preset condition, determines that the encoding mode is the first encoding mode; or when the quantity of heterogeneous sound sources does not meet the second preset condition, determines that the encoding mode is the second encoding mode. In this embodiment of this application, whether the quantity of heterogeneous sound sources meets the second preset condition may be determined, to implement division of the encoding mode of the current frame, to accurately identify that the encoding mode of the current frame belongs to the first encoding mode or the second encoding mode.

In one embodiment, the second preset condition includes that the quantity of heterogeneous sound sources is greater than the first threshold and less than the second threshold, and the second threshold is greater than the first threshold; or the second preset condition includes that the quantity of heterogeneous sound sources is not greater than the first threshold or not less than the second threshold, and the second threshold is greater than the first threshold.

In one embodiment, the determining, based on the sound field type, the encoding mode corresponding to the current frame includes: when the sound field type is a heterogeneous sound field, determining that the encoding mode is an HOA encoding mode based on virtual speaker selection; or when the sound field type is a dispersive sound field, determining that the encoding mode is an HOA encoding mode based on directional audio coding.

In one embodiment, the determining, based on the sound field classification result, an encoding mode corresponding to the current frame includes: determining, based on the sound field classification result of the current frame, an initial encoding mode corresponding to the current frame; obtaining a hangover window in which the current frame is located, where the hangover window includes the initial encoding mode of the current frame and encoding modes of N−1 frames before the current frame, and N is a length of the hangover window; and determining the encoding mode of the current frame based on the initial encoding mode of the current frame and the encoding modes of the N−1 frames. In the foregoing solutions, in this embodiment of this application, the initial encoding mode of the current frame is corrected based on the hangover window, to obtain the encoding mode of the current frame. This ensures that encoding modes of consecutive frames are not frequently switched, and improves encoding efficiency.

In one embodiment, the method further includes: determining, based on the sound field classification result, an encoding parameter corresponding to the current frame. In the foregoing solutions, the encoder side may determine, based on the sound field classification result, the encoding parameter corresponding to the current frame. The encoding parameter is a parameter used when the current frame of the three-dimensional audio signal is encoded. There are a plurality of encoding parameters, and different encoding parameters may be used based on different sound field classification results of the current frame. In this embodiment of this application, appropriate encoding parameters are selected for different sound field classification results of the current frame, so that the current frame is encoded based on the encoding parameter. This improves compression efficiency and auditory quality of an audio signal.

In one embodiment, the encoding parameter includes at least one of the following: a quantity of channels of a virtual speaker signal, a quantity of channels of a residual signal, a quantity of encoding bits of a virtual speaker signal, a quantity of encoding bits of a residual signal, or a quantity of voting rounds for searching for a best matching speaker. The virtual speaker signal and the residual signal are generated based on the three-dimensional audio signal.

In one embodiment, the quantity of voting rounds meets the following relationship: 1≤I≤d. I is the quantity of voting rounds, and d is the quantity of heterogeneous sound sources included in the sound field classification result. In the foregoing solutions, the encoder side determines, based on the quantity of heterogeneous sound sources of the current frame, the quantity of voting rounds for searching for the best matching speaker. The quantity of voting rounds is less than or equal to the quantity of heterogeneous sound sources of the current frame, so that the quantity of voting rounds can comply with an actual situation of sound field classification of the current frame. This resolves a problem that the quantity of voting rounds for searching for the best matching speaker needs to be determined when the current frame is encoded.

In one embodiment, the sound field classification result includes the quantity of heterogeneous sound sources and the sound field type. When the sound field type is a heterogeneous sound field, the quantity of channels of the virtual speaker signal meets the following relationship: F=min(S, PF), where F is the quantity of channels of the virtual speaker signal, S is the quantity of heterogeneous sound sources, and PF is a quantity of channels of the virtual speaker signal preset by an encoder; or when the sound field type is a dispersive sound field, the quantity of channels of the virtual speaker signal meets the following relationship: F=1, where F is the quantity of channels of the virtual speaker signal. In the foregoing solutions, the quantity of channels of the virtual speaker signal is a quantity of channels for transmitting the virtual speaker signal, and the quantity of channels of the virtual speaker signal may be determined based on the quantity of heterogeneous sound sources and the sound field type. In the foregoing calculation manner, when the sound field type is a dispersive sound field, it is determined that the quantity of channels of the virtual speaker signal is 1, to improve encoding efficiency of the current frame. When the sound field type is a heterogeneous sound field, min indicates an operation in which a minimum value is selected, that is, selecting a minimum value from S and PF as the quantity of channels of the virtual speaker signal, so that the quantity of channels of the virtual speaker signal can comply with an actual situation of sound field classification of the current frame. This resolves a problem that the quantity of channels of the virtual speaker signal needs to be determined when the current frame is encoded.

In one embodiment, when the sound field type is a dispersive sound field, the quantity, of channels of the residual signal meets the following relationship: R=max(C−1, PR), where PR is a quantity of channels of the residual signal preset by the encoder, and C is a sum of the quantity of channels of the residual signal preset by the encoder and the quantity of channels of the virtual speaker signal preset by the encoder; or when the sound field type is a heterogeneous sound field, the quantity of channels of the residual signal meets the following relationship: R=C−F, where R is the quantity of channels of the residual signal, C is a sum of a quantity of channels of the residual signal preset by the encoder and the quantity of channels of the virtual speaker signal preset by the encoder, and F is the quantity of channels of the virtual speaker signal. In the foregoing solutions, after the quantity of channels of the virtual speaker signal is obtained, the quantity of channels of the residual signal may be calculated based on the preset quantity of channels of the residual signal and the sum of the preset quantity of channels of the residual signal and the preset quantity of channels of the virtual speaker signal. A value of PR may be preset at the encoder side, and a value of R may be obtained according to the formula for calculating max(C−1, PR). The sum of the preset quantity of channels of the residual signal and the preset quantity of channels of the virtual speaker signal is preset at the encoder side. In addition, C may also be referred to as a total quantity of transmission channels.

In one embodiment, the sound field classification result includes the quantity of heterogeneous sound sources. The quantity of channels of the virtual speaker signal meets the following relationship: F=min(S, PF), where F is the quantity of channels of the virtual speaker signal, S is the quantity of heterogeneous sound sources, and PF is a quantity of channels of the virtual speaker signal preset by an encoder.

In one embodiment, the quantity of channels of the residual signal meets the following relationship: R=C−F, where R is the quantity of channels of the residual signal, C is a sum of a quantity of channels of the residual signal preset by the encoder and the quantity of channels of the virtual speaker signal preset by the encoder, and is the quantity of channels of the virtual speaker signal. In the foregoing solutions, after the quantity of channels of the virtual speaker signal is obtained, the quantity of channels of the residual signal may be calculated based on the quantity of channels of the virtual speaker signal and the sum of the preset quantity of channels of the residual signal and the preset quantity of channels of the virtual speaker signal. The sum of the preset quantity of channels of the residual signal and the preset quantity of channels of the virtual speaker signal is preset at the encoder side. In addition, C may also be referred to as a total quantity of transmission channels.

In one embodiment, the sound field classification result includes the quantity of heterogeneous sound sources, or the sound field classification result includes the quantity of heterogeneous sound sources and the sound field type. The quantity of encoding bits of the virtual speaker signal is obtained based on a ratio of the quantity of encoding bits of the virtual speaker signal to a quantity of encoding bits of a transmission channel. The quantity of encoding bits of the residual signal is obtained based on the ratio of the quantity of encoding bits of the virtual speaker signal to the quantity of encoding bits of the transmission channel. The quantity of encoding bits of the transmission channel includes the quantity of encoding bits of the virtual speaker signal and the quantity of encoding bits of the residual signal, and when the quantity of heterogeneous sound sources is less than or equal to the quantity of channels of the virtual speaker signal, the ratio of the quantity of encoding bits of the virtual speaker signal to the quantity of encoding bits of the transmission channel is obtained by increasing an initial ratio of the quantity of encoding bits of the virtual speaker signal to the quantity of encoding bits of the transmission channel.

In one embodiment, the method further includes: encoding the current frame and the sound field classification result, and writing the encoded current frame and sound field classification result into a bitstream.

According to a second aspect, an embodiment of this application further provides a three-dimensional audio signal processing method, including: receiving a bitstream; decoding the bitstream, to obtain a sound field classification result of a current frame; and obtaining a three-dimensional audio signal of the decoded current frame based on the sound field classification result. In the foregoing solutions, the sound field classification result can be used to decode the current frame in the bitstream. Therefore, a decoder side performs decoding in a decoding manner matching a sound field of the current frame, to obtain the three-dimensional audio signal sent by an encoder side. This implements transmission of the audio signal from the encoder side to the decoder side.

In one embodiment, the obtaining a three-dimensional audio signal of the decoded current frame based on the sound field classification result includes: determining a decoding mode of the current frame based on the sound field classification result; and obtaining the three-dimensional audio signal of the decoded current frame based on the decoding mode.

In one embodiment, the determining a decoding mode of the current frame based on the sound field classification result includes: when the sound field classification result includes a quantity of heterogeneous sound sources, or the sound field classification result includes a quantity of heterogeneous sound sources and a sound field type, determining the decoding mode of the current frame based on the quantity of heterogeneous sound sources; when the sound field classification result includes a sound field type, or the sound field classification result includes a quantity of heterogeneous sound sources and a sound field type, determining the decoding mode of the current frame based on the sound field type; or when the sound field classification result includes a quantity of heterogeneous sound sources and a sound field type, determining the decoding mode of the current frame based on the quantity of heterogeneous sound sources and the sound field type.

In one embodiment, the determining, based on the quantity of heterogeneous sound sources, the decoding mode corresponding to the current frame includes: when the quantity of heterogeneous sound sources meets a preset condition, determining that the decoding mode is a first decoding mode; or when the quantity of heterogeneous sound sources does not meet a preset condition, determining that the decoding mode is a second decoding mode. The first decoding mode is an HOA decoding mode based on virtual speaker selection or an HOA decoding mode based on directional audio coding, the second decoding mode is an HOA decoding mode based on virtual speaker selection or an HOA decoding mode based on directional audio coding, and the first decoding mode and the second decoding mode are different decoding modes.

In one embodiment, the preset condition includes that the quantity of heterogeneous sound sources is greater than a first threshold and less than a second threshold, and the second threshold is greater than the first threshold; or the preset condition includes that the quantity of heterogeneous sound sources is not greater than a first threshold or not less than a second threshold, and the second threshold is greater than the first threshold.

In one embodiment, the obtaining a three-dimensional audio signal of the decoded current frame based on the sound field classification result includes: determining a decoding parameter of the current frame based on the sound field classification result; and obtaining the three-dimensional audio signal of the decoded current frame based on the decoding parameter.

In one embodiment, the decoding parameter includes at least one of the following: a quantity of channels of a virtual speaker signal, a quantity of channels of a residual signal, a quantity of decoding bits of a virtual speaker signal, or a quantity of decoding bits of a residual signal. The virtual speaker signal and the residual signal are obtained by decoding the bitstream.

In one embodiment, the sound field classification result includes the quantity of heterogeneous sound sources and the sound field type. When the sound field type is a heterogeneous sound field, the quantity of channels of the virtual speaker signal meets the following relationship: F=min(S, PF), where F is the quantity of channels of the virtual speaker signal, S is the quantity of heterogeneous sound sources, and PF is a quantity of channels of the virtual speaker signal preset by a decoder; or when the sound field type is a dispersive sound field, the quantity of channels of the virtual speaker signal meets the following relationship: F=1, where F is the quantity of channels of the virtual speaker signal.

In one embodiment, when the sound field type is a dispersive sound field, the quantity of channels of the residual signal meets the following relationship: R=max(C−1, PR), where PR is a quantity of channels of the residual signal preset by the decoder, and C is a sum of the quantity of channels of the residual signal preset by the decoder and the quantity of channels of the virtual speaker signal preset by the decoder; or when the sound field type is a heterogeneous sound field, the quantity of channels of the residual signal meets the following relationship: R=C−F, where R is the quantity of channels of the residual signal, C is a sum of a quantity of channels of the residual signal preset by the decoder and the quantity of channels of the virtual speaker signal preset by the decoder, and F is the quantity of channels of the virtual speaker signal.

In one embodiment, the sound field classification result includes the quantity of heterogeneous sound sources. The quantity of channels of the virtual speaker signal meets the following relationship: F=min(S, PF), where F is the quantity of channels of the virtual speaker signal, S is the quantity of heterogeneous sound sources, and PF is a quantity of channels of the virtual speaker signal preset by a decoder.

In one embodiment, the quantity of channels of the residual signal meets the following relationship: R=C−F, where R is the quantity of channels of the residual signal, C is a sum of a quantity of channels of the residual signal preset by the decoder and the quantity of channels of the virtual speaker signal preset by the decoder, and F is the quantity of channels of the virtual speaker signal.

In one embodiment, the sound field classification result includes the quantity of heterogeneous sound sources, or the sound field classification result includes the quantity of heterogeneous sound sources and the sound field type. The quantity of decoding bits of the virtual speaker signal is obtained based on a ratio of the quantity of decoding bits of the virtual speaker signal to a quantity of decoding bits of a transmission channel. The quantity of decoding bits of the residual signal is obtained based on a ratio of the quantity of decoding bits of the virtual speaker signal to the quantity of decoding bits of the transmission channel. The quantity of decoding bits of the transmission channel includes the quantity of decoding bits of the virtual speaker signal and the quantity of decoding bits of the residual signal, and when the quantity of heterogeneous sound sources is less than or equal to the quantity of channels of the virtual speaker signal, the ratio of the quantity of decoding bits of the virtual speaker signal to the quantity of decoding bits of the transmission channel is obtained by increasing an initial ratio of the quantity of decoding bits of the virtual speaker signal to the quantity of decoding bits of the transmission channel.

According to a third aspect, an embodiment of this application further provides a three-dimensional audio signal processing apparatus, including: a linear analysis module, configured to perform linear decomposition on a three-dimensional audio signal, to obtain a linear decomposition result; a parameter generation module, configured to obtain, based on the linear decomposition result, a sound field classification parameter corresponding to a current frame; and a sound field classification module, configured to determine a sound field classification result of the current frame based on the sound field classification parameter.

In the third aspect in this application, modules included in the three-dimensional audio signal processing apparatus may further perform operations described in the first aspect and the possible implementations. For details, refer to descriptions of the first aspect and the possible implementations.

According to a fourth aspect, an embodiment of this application further provides a three-dimensional audio signal processing apparatus, including: a receiving module, configured to receive a bitstream; a decoding module, configured to decode the bitstream, to obtain a sound field classification result of a current frame; and a signal generation module, configured to obtain a three-dimensional audio signal of the decoded current frame based on the sound field classification result.

In the fourth aspect in this application, modules included in the three-dimensional audio signal processing apparatus may further perform operations described in the second aspect and the possible implementations. For details, refer to descriptions of the second aspect and the possible implementations.

In one embodiment, a quantity of encoding bits of a virtual speaker signal meets the following relationship:

$$core\_numbit = round ( fac 1 * F * \frac{numbit}{fac 1 * F + fac 2 * R} )$$

core_numbit is the quantity of encoding bits of the virtual speaker signal, fac1 is a weighting factor allocated to the encoding bit of the virtual speaker signal, fac2 is a weighting factor allocated to an encoding bit of a residual signal, round indicates rounding down, F is a quantity of channels of the virtual speaker signal, R indicates a quantity of channels of the residual signal, and numbit is a sum of the quantity of encoding bits of the virtual speaker signal and a quantity of encoding bits of the residual signal. The quantity of encoding bits of the residual signal meets the following relationship:

re_numbit=numbit−core_numbit

re_numbit is the quantity of encoding bits of the residual signal, core_numbit is the quantity of encoding bits of the virtual speaker signal, and numbit is the sum of the quantity of encoding bits of the virtual speaker signal and the quantity of encoding bits of the residual signal.

In one embodiment, fac1>fac2.

In one embodiment, the quantity of encoding bits of the residual signal meets the following relationship:

$$res\_numbit = round ( fac 2 * R * \frac{numbit}{fac 1 * F + fac 2 * R} )$$

re_numbit is the quantity of encoding bits of the residual signal, fac1 is the weighting factor allocated to the encoding bit of the virtual speaker signal, fac2 is the weighting factor allocated to the encoding bit of the residual signal, round indicates rounding down, F is the quantity of channels of the virtual speaker signal, R indicates the quantity of channels of the residual signal, and numbit is the sum of the quantity of encoding bits of the virtual speaker signal and the quantity of encoding bits of the residual signal.

The quantity of encoding bits of the virtual speaker signal meets the following relationship:

core_numbit=numbit−re_numbit

core_numbit is the quantity of encoding bits of the virtual speaker signal, re_numbit is the quantity of encoding bits of the residual signal, and numbit is the sum of the quantity of encoding bits of the virtual speaker signal and the quantity of encoding bits of the residual signal.

In one embodiment, a quantity of encoding bits of each virtual speaker signal meets the following relationship:

$$core\_ch \_numbit = round ( fac 1 * \frac{numbit}{fac 1 * F + fac 2 * R} )$$

core_ch_numbit is the quantity of encoding bits of each virtual speaker signal, fac1 is the weighting factor allocated to the encoding bit of the virtual speaker signal, fac2 is the weighting factor allocated to the encoding bit of the residual signal, round indicates rounding down, F is the quantity of channels of the virtual speaker signal, R indicates the quantity of channels of the residual signal, and numbit is the sum of the quantity of encoding bits of the virtual speaker signal and the quantity of encoding bits of the residual signal.

A quantity of encoding bits of each residual signal meets the following relationship:

$$res\_ch \_numbit = round ( fac 2 * \frac{numbit}{fac 1 * F + fac 2 * R} )$$

res_numbit is the quantity of encoding bits of each residual signal, fac1 is the weighting factor allocated to the encoding hit of the virtual speaker signal, fac2 is the weighting factor allocated to the encoding hit of the residual signal, round indicates rounding down, F is the quantity of channels of the virtual speaker signal, R indicates the quantity of channels of the residual signal, and numbit is the sum of the quantity of encoding bits of the virtual speaker signal and the quantity of encoding bits of the residual signal.

According to a fifth aspect, an embodiment of this application provides a computer-readable storage medium. The computer-readable storage medium stores instructions. When the instructions are run on a computer, the computer is enabled to perform the method in the first aspect or the second aspect.

According to a sixth aspect, an embodiment of this application provides a computer program product including instructions. When the computer program product runs on a computer, the computer is enabled to perform the method in the first aspect or the second aspect.

According to a seventh aspect, an embodiment of this application provides a computer-readable storage medium, including the bitstream generated in the method in the first aspect.

According to an eighth aspect, an embodiment of this application provides a communication apparatus. The communication apparatus may include an entity such as a terminal device or a chip. The communication apparatus includes a processor and a memory. The memory is configured to store instructions, and the processor is configured to execute the instructions in the memory, to enable the communication apparatus to perform the method in any one of the implementations of the first aspect or the second aspect.

According to a ninth aspect, this application provides a chip system. The chip system includes a processor, configured to support an audio encoder or an audio decoder in implementing functions in the foregoing aspects, for example, sending or processing data and/or information in the foregoing method. In a possible design, the chip system further includes a memory. The memory is configured to store program instructions and data that are necessary for the audio encoder or the audio decoder. The chip system may include a chip, or may include a chip and another discrete component.

It can be learned from the foregoing technical solutions that embodiments of this application have the following advantages:

In this embodiment of this application, linear decomposition is first performed on the current frame of the three-dimensional audio signal, to obtain the linear decomposition result. Then, the sound field classification parameter corresponding to the current frame is obtained based on the linear decomposition result. Finally, the sound field classification result of the current frame is determined based on the sound field classification parameter. In this embodiment of this application, linear decomposition is performed on the current frame of the three-dimensional audio signal, to obtain the linear decomposition result of the current frame. Then, the sound field classification parameter corresponding to the current frame is obtained based on the linear decomposition result. Therefore, the sound field classification result of the current frame is determined based on the sound field classification parameter, and sound field classification of the current frame can be implemented based on the sound field classification result. In this embodiment of this application, sound field classification is performed on the three-dimensional audio signal, to accurately identify the three-dimensional audio signal.

### BRIEF DESCRIPTION OF DRAWINGS

FIG. 1 is a schematic diagram of a structure of composition of an audio processing system according to an embodiment of this application;

FIG. 2a is a schematic diagram in which an audio encoder and an audio decoder are used in a terminal device according to an embodiment of this application;

FIG. 2b is a schematic diagram in which an audio encoder is used in a wireless device or a core network device according to an embodiment of this application;

FIG. 2c is a schematic diagram in which an audio decoder is used in a wireless device or a core network device according to an embodiment of this application;

FIG. 3a is a schematic diagram in which a multi-channel encoder and a multi-channel decoder are used in a terminal device according to an embodiment of this application;

FIG. 3b is a schematic diagram in which a multi-channel encoder is used in a wireless device or a core network device according to an embodiment of this application;

FIG. 3c is a schematic diagram in which a multi-channel decoder is used in a wireless device or a core network device according to an embodiment of this application;

FIG. 4 is a schematic diagram of a three-dimensional audio signal processing method according to an embodiment of this application:

FIG. 5 is a schematic diagram of a three-dimensional audio signal processing method according to an embodiment of this application;

FIG. 6 is a schematic diagram of a three-dimensional audio signal processing method according to an embodiment of this application;

FIG. 7 is a schematic diagram of a three-dimensional audio signal processing method according to an embodiment of this application;

FIG. 8 is a schematic flowchart of encoding of a hybrid HOA encoder according to an embodiment of this application;

FIG. 9 is a schematic flowchart of determining an encoding mode of an HOA signal according to an embodiment of this application;

FIG. 10 is a schematic flowchart of decoding of a hybrid HOA decoder according to an embodiment of this application;

FIG. 11 is a schematic flowchart of encoding of an MP-based HOA encoder according to an embodiment of this application;

FIG. 12 is a schematic diagram of a structure of composition of an audio encoding apparatus according to an embodiment of this application;

FIG. 13 is a schematic diagram of a structure of composition of an audio decoding apparatus according to an embodiment of this application;

FIG. 14 is a schematic diagram of a structure of composition of another audio encoding apparatus according to an embodiment of this application; and

FIG. 15 is a schematic diagram of a structure of composition of another audio decoding apparatus according to an embodiment of this application.

### DESCRIPTION OF EMBODIMENTS

The following describes embodiments of this application with reference to the accompanying drawings.

In the specification, claims, and the accompanying drawings of this application, terms “first”, “second”, and the like are intended to distinguish similar objects but do not necessarily indicate a specific order or sequence. It should be understood that the terms used in such a way are interchangeable in proper circumstances, which is merely a discrimination manner that is used when objects having a same attribute are described in embodiments of this application. In addition, the terms “include”, “contain” and any other variants mean to cover the non-exclusive inclusion, so that a process, method, system, product, or device that includes a series of units is not necessarily limited to those units, but may include other units not expressly listed or inherent to such a process, method, system, product, or device.

Sound (sound) is a continuous wave generated by vibration of an object. The object that emits the sound wave due to vibration is referred to as a sound source. When the sound wave propagates through a medium (for example, air, solid, or liquid), human or animal auditory organs can sense the sound.

Features of the sound wave include a tone, a sound intensity, and a timbre. The tone indicates a pitch of the sound. The sound intensity indicates an intensity of the sound. The sound intensity may also be referred to as loudness or volume. A unit of the sound intensity is decibel (dB). The timbre is also referred to as sound quality.

A frequency of the sound wave determines a pitch of the tone. A higher frequency indicates a higher pitch. A quantity of times that an object vibrates in one second is referred to as a frequency, and a unit of the frequency is hertz (Hz). A frequency of sound recognized by a human ear ranges from 20 Hz to 20,000 Hz.

Amplitude of the sound wave determines an intensity of the sound intensity. Larger amplitude indicates a larger sound intensity. A closer distance to the sound source indicates a larger sound intensity.

A waveform of the sound wave determines a timbre. Waveforms of the sound wave include a square wave, a sawtooth wave, a sine wave, and a pulse wave.

The sound may be divided into regular sound and irregular sound based on the features of the sound wave. The irregular sound is sound generated by irregular vibration of the sound source. The irregular sound is, for example, noise that affects human work, study, rest, and the like. The regular sound is sound generated by regular vibration of the sound source. The regular sound includes speech and music. When sound is represented by electricity, the regular sound is an analog signal that changes continuously in time-frequency domain. The analog signal may be referred to as an audio signal (acoustic signal). The audio signal is an information carrier that carries speech, music, and sound effect.

Because a human auditory sense can distinguish position distribution of a sound source in space, when hearing sound in space, a listener can sense not only a tone, a sound intensity, and a timbre of the sound, but also a position of the sound.

With increasing attention and quality requirements of auditory system experience, a three-dimensional audio technology emerges, to enhance senses of a longitudinal depth, immersion, and space of sound. Therefore, the listener can hear sound emitted from the front, rear, left and right sound sources, feel that space in which the listener is located is surrounded by a spatial sound field (which is referred to as a sound field) generated by the sound sources, and feel that the sound spreads around. The three-dimensional audio technology creates “immersed” stereo effect that makes the listener feel like being in places such as a cinema or a concert hall.

The three-dimensional audio technology is a technology in which space outside a human ear is assumed as a system, and a signal received by an eardrum is a three-dimensional audio signal that is obtained by filtering and outputting, by the system outside the ear, the sound emitted by the sound source. For example, the system outside the human ear may be defined as a system impact response h(n), any sound source may be defined as x(n), and the signal received by the eardrum is a convolution result of x(n) and h(n). In embodiments of this application, the three-dimensional audio signal may be a higher-order ambisonics (HOA) signal or a first-order ambisonics (FOA) signal. Three-dimensional audio may also be referred to as three-dimensional sound effect, spatial audio, three-dimensional sound field reconstruction, virtual 3D audio, binaural audio, or the like.

The sound wave propagates in an ideal medium with a quantity of waves of k=w/c and an angular frequency of w=2πf. f is a frequency of the sound wave, and c is a sound speed. A sound pressure meets a formula (1), and ∇² is a Laplace operator.

∇²p+k²p=0 formula (1)

It is assumed that the space system outside the human ear is a sphere, and the listener is at a center of the sphere. Sound from outside the sphere has a projection on a surface of the sphere, and sound outside the sphere is filtered out. It is assumed that a sound source is distributed on the sphere. A sound field generated by the sound source on the surface of the sphere is used to fit a sound field generated by an original sound source, that is, the three-dimensional audio technology is a sound field fitting method. Specifically, the equation of the formula (1) is solved in a spherical coordinate system, and in a passive spherical area, the equation of the formula (1) is solved as the following formula (2):

p(r, θ, φ, k)=sΣₘ₌₀^{∞}(2m+1)j^{m}jₘ^{kr}(kr)Σ_{0≤n≤m, σ=±1}Y_{m,n}^{σ}(θₛ, φₛ)Y_{m,n}^{σ}(θ, φ) formula (2)

r indicates a spherical radius, θ indicates a horizontal angle, φ indicates an elevation angle, k indicates a quantity of waves, s indicates amplitude of an ideal plane wave, and m indicates an order sequence number (which is also referred to as an order sequence number of an HOA signal) of a three-dimensional audio signal. j^{m}jₘ^{kr} (kr) indicates a spherical Bessel function, where the spherical Bessel function is also referred to as a radial basis function, a first j indicates an imaginary unit, and (2m+1)j^{m}jₘ^{kr} (kr) does not vary with an angle. Y_{m,n}^{σ}(θ, φ) indicates a spherical harmonic function in a direction of θ, φ, and Y_{m,n}^{σ}(θₛ, φₛ) indicates a spherical harmonic function in a direction of the sound source. A coefficient of a three-dimensional audio signal meets a formula (3):

B_{m,n}^{σ}=s·Y_{m,n}^{σ}(θₛ, φₛ) formula (3)

The formula (3) is substituted into the formula (2), and the formula can be transformed into a formula (4):

p(r, θ, φ, k)=Σₘ₌₀^{∞}j^{m}jₘ^{kr}(kr)Σ_{0≤n≤m, σ=±1}B_{m,n}^{σ}Y_{m,n}^{σ}(θ, φ) formula (4)

B_{m,n}^{σ} indicates a coefficient of an N^{th}-order three-dimensional audio signal, and is used to approximately describe a sound field. The sound field is an area in which a sound wave exists in a medium. N is an integer greater than or equal to 1. For example, a value of N is an integer ranging from 2 to 6. The coefficient of the three-dimensional audio signal in embodiments of this application may be an HOA coefficient or an ambisonic (ambisonic) coefficient.

The three-dimensional audio signal is an information carrier that carries spatial position information of a sound source in a sound field, and describes a sound field of a listener in space. The formula (4) shows that the sound field can be expanded on the surface of the sphere as a spherical harmonic function, that is, the sound field can be decomposed into superimposition of a plurality of plane waves. Therefore, the sound field described by the three-dimensional audio signal can be expressed by using superimposition of the plurality of plane waves, and the sound field can be reconstructed based on the coefficient of the three-dimensional audio signal.

Compared with a 5.1-channel audio signal or a 7.1-channel audio signal, an N^{th}-order HOA signal has (N+1)² channels. Therefore, the HOA signal includes a large amount of data used to describe spatial information of a sound field. If an acquisition device (for example, a microphone) transmits the three-dimensional audio signal to a playback device (for example, a speaker), a large bandwidth needs to be consumed. Currently, an encoder may compress and encode a three-dimensional audio signal by using a spatially squeezed surround audio coding (spatially squeezed surround audio coding, S3AC) method, a directional audio coding (directional audio coding, DirAC) method, or an encoding method based on virtual speaker selection, to obtain a bitstream, and transmit the bitstream to the playback device. The encoding method based on virtual speaker selection may also be referred to as a match projection (match projection, MP) encoding method. In the following, the encoding method based on virtual speaker selection is used as an example for description. The playback device decodes the bit stream, reconstructs the three-dimensional audio signal, and plays a reconstructed three-dimensional audio signal. This reduces a data amount for transmitting the three-dimensional audio signal to the playback device and bandwidth occupation.

For the three-dimensional audio signal, currently, a sound field of the three-dimensional audio signal cannot be classified. How to classify the sound field of the three-dimensional audio signal is a technical problem to be resolved in embodiments of this application. In embodiments of this application, linear decomposition is performed on the three-dimensional audio signal, to implement sound field classification of the three-dimensional audio signal. This can accurately implement sound field classification of the three-dimensional audio signal, and obtain a sound field classification result of a current frame.

In addition, when the current encoder compresses and encodes a three-dimensional audio signal, a high compression ratio cannot be obtained. Therefore, how to increase a compression ratio for performing compression encoding on three-dimensional audio signals of different sound fields is another problem to be resolved in embodiments of this application.

An embodiment of this application provides an audio encoding technology, and in particular, provides a three-dimensional audio encoding technology oriented to a three-dimensional audio signal. Specifically, an encoding technology in which a three-dimensional audio signal is represented by using fewer channels is provided, to improve a conventional audio encoding system. Audio coding (or commonly referred to as coding) includes two parts: audio encoding and audio decoding. Audio encoding is performed at a source side, and includes processing (for example, compression) original audio, to reduce a data amount required to represent the audio. This improves efficiency of storage and/or transmission. Audio decoding is performed at a destination side, and includes inverse processing relative to the encoder, to reconstruct the original audio. The encoding part and the decoding part are also referred to as coding. The following describes the implementations of embodiments of this application in detail with reference to accompanying drawings.

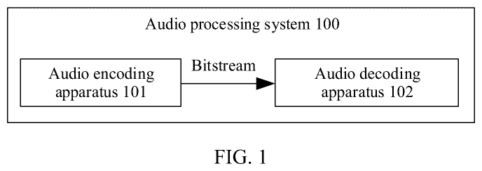

The technical solutions in embodiments of this application may be applied to various audio processing systems. FIG. 1 is a schematic diagram of a structure of composition of an audio processing system according to an embodiment of this application. An audio processing system 100 may include an audio encoding apparatus 101 and an audio decoding apparatus 102. The audio encoding apparatus 101 may be configured to generate a bitstream. Then, the audio encoding bitstream may be transmitted to the audio decoding apparatus 102 through an audio transmission channel. The audio decoding apparatus 102 may receive the bitstream, then perform an audio decoding function of the audio decoding apparatus 102, to obtain a reconstructed signal.

In this embodiment of this application, the audio encoding apparatus may be used in various terminal devices that require audio communication, and wireless devices and core network devices that require transcoding. For example, the audio encoding apparatus may be an audio encoder of the terminal device, the wireless device, or the core network device. Similarly, the audio decoding apparatus may be used in various terminal devices that require audio communication, and wireless devices and core network devices that require transcoding. For example, the audio decoding apparatus may be an audio decoder of the terminal device, the wireless device, or the core network device. For example, the audio encoder may include a radio access network, a media gateway in a core network, a transcoding device, a media resource server, a mobile terminal, a fixed network terminal, and the like. Alternatively, the audio encoder may be an audio encoder used in a virtual reality (VR) streaming (streaming) media service.

In this embodiment of this application, an audio coding (audio encoding and audio decoding) module applicable to a virtual reality streaming (VR streaming) media service is used as an example. An end-to-end audio signal processing procedure includes: After an audio signal A passes through an acquisition (acquisition) module, a preprocessing (audio preprocessing) operation is performed. The preprocessing operation includes: filtering out a low-frequency part of the signal, where filtering may be performed by using 20 Hz or 50 Hz as a demarcation point; and extracting orientation information of the signal. Then, encoding (audio encoding) and encapsulation (file/segment encapsulation) are performed, and a signal is delivered (delivery) to a decoder side. The decoder side first performs decapsulation (file/segment decapsulation), then performs decoding (audio decoding), and performs binaural rendering (audio rendering) on a decoded signal. A signal obtained through rendering is mapped to a headset (headphones) of a listener, where the headset may be an independent headset or a headset on a glasses device.

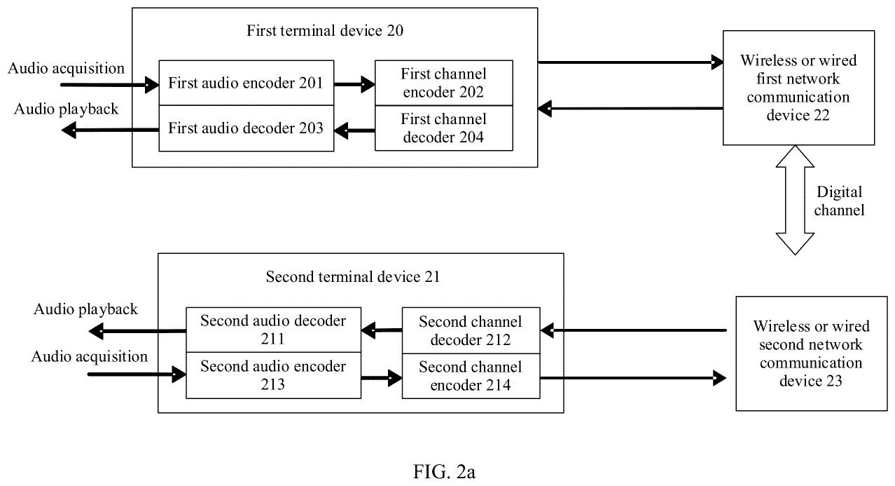

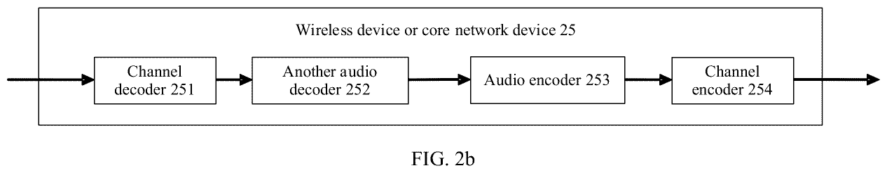

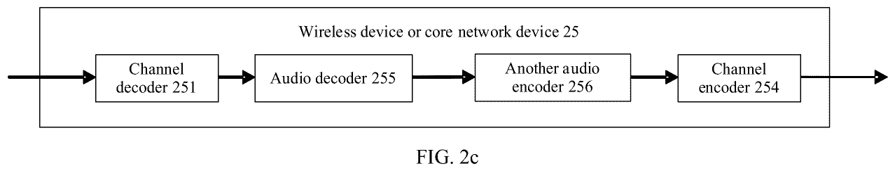

FIG. 2a is a schematic diagram in which an audio encoder and an audio decoder are used in a terminal device according to an embodiment of this application. Each terminal device may include an audio encoder, a channel encoder, an audio decoder, and a channel decoder. Specifically, the channel encoder is configured to perform channel encoding on an audio signal, and the channel decoder is configured to perform channel decoding on the audio signal. For example, a first terminal device 20 may include a first audio encoder 201, a first channel encoder 202, a first audio decoder 203, and a first channel decoder 204. A second terminal device 21 may include a second audio decoder 211, a second channel decoder 212, a second audio encoder 213, and a second channel encoder 214. The first terminal device 20 is connected to a wireless or wired first network communication device 22, the first network communication device 22 is connected to a wireless or wired second network communication device 23 through a digital channel, and the second terminal device 21 is connected to the wireless or wired second network communication device 23. The wireless or wired network communication device may be a signal transmission device in general, for example, a communication base station or a data switching device.

In audio communication, a terminal device serving as a transmit end first performs audio acquisition, performs audio encoding on an acquired audio signal, then performs channel encoding, and transmits an encoded signal in a digital channel through a wireless network or a core network. The terminal device serving as a receive end performs channel decoding based on the received signal, to obtain a bitstream, and then restores an audio signal through audio decoding. The terminal device at the receive end performs audio playback.

FIG. 2b is a schematic diagram in which an audio encoder is used in a wireless device or a core network device according to an embodiment of this application. A wireless device or core network device 25 includes: a channel decoder 251, another audio decoder 252, an audio encoder 253 provided in this embodiment of this application, and a channel encoder 254. The another audio decoder 252 is another audio decoder other than the audio decoder. In the wireless device or core network device 25, the channel decoder 251 first performs channel decoding on a signal entering the device, and then the another audio decoder 252 performs audio decoding. Then, the audio encoder 253 provided in this embodiment of this application performs audio encoding, and finally the channel encoder 254 performs channel encoding on an audio signal, and then transmits an encoded audio signal after channel encoding is completed. The another audio decoder 252 performs audio decoding on a bitstream decoded by the channel decoder 251.

FIG. 2c is a schematic diagram in which an audio decoder is used in a wireless device or a core network device according to an embodiment of this application. The wireless device or core network device 25 includes: the channel decoder 251, an audio decoder 255 provided in this embodiment of this application, another audio encoder 256, and the channel encoder 254. The another audio encoder 256 is another audio encoder other than the audio encoder. In the wireless device or core network device 25, the channel decoder 251 first performs channel decoding on a signal entering the device, and then the audio decoder 255 decodes a received audio encoding bitstream. Then, the another audio encoder 256 performs audio encoding, and finally the channel encoder 254 performs channel encoding on an audio signal, and then transmits an encoded audio signal after channel encoding is completed. In the wireless device or core network device, if transcoding needs to be implemented, corresponding audio encoding processing needs to be performed. The wireless device is a radio frequency-related device in communication, and the core network device is a core network-related device in communication.

In some embodiments of this application, the audio encoding apparatus may be used in various terminal devices that require audio communication, and wireless devices and core network devices that require transcoding. For example, the audio encoding apparatus may be a multi-channel encoder of the terminal device, the wireless device, or the core network device. Similarly, the audio decoding apparatus may be used in various terminal devices that require audio communication, and wireless devices and core network devices that require transcoding. For example, the audio decoding apparatus may be a multi-channel decoder of the terminal device, the wireless device, or the core network device.

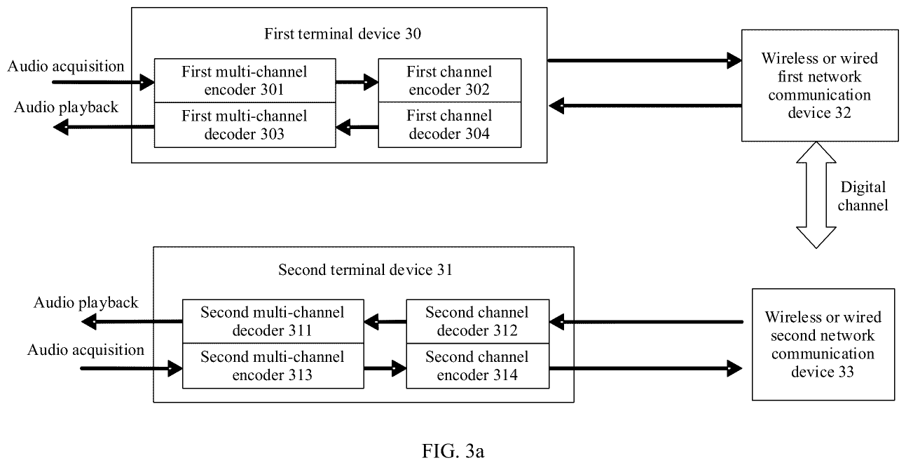

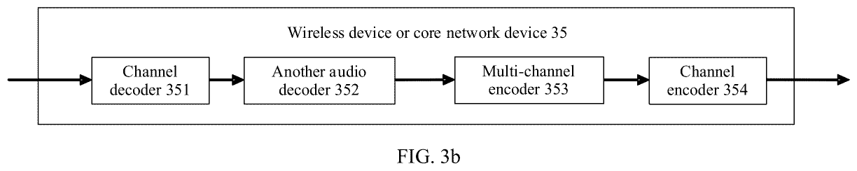

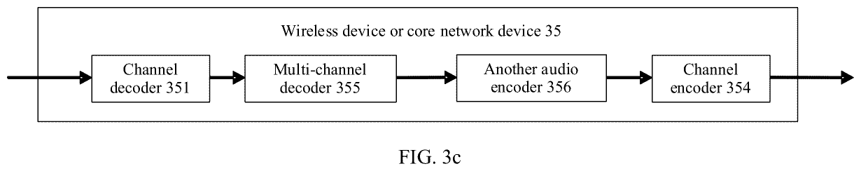

FIG. 3a is a schematic diagram of application of a multi-channel encoder and a multi-channel decoder to a terminal device according to an embodiment of this application. Each terminal device may include a multi-channel encoder, a channel encoder, a multi-channel decoder, and a channel decoder. The multi-channel encoder may perform an audio encoding method provided in embodiments of this application, and the multi-channel decoder may perform an audio decoding method provided in embodiments of this application. Specifically, the channel encoder is configured to perform channel encoding on a multi-channel signal, and the channel decoder is configured to perform channel decoding on the multi-channel signal. For example, a first terminal device 30 may include a first multi-channel encoder 301, a first channel encoder 302, a first multi-channel decoder 303, and a first channel decoder 304. A second terminal device 31 may include a second multi-channel decoder 311, a second channel decoder 312, a second multi-channel encoder 313, and a second channel encoder 314. The first terminal device 30 is connected to a wireless or wired first network communication device 32, the first network communication device 32 is connected to a wireless or wired second network communication device 33 through a digital channel, and the second terminal device 31 is connected to the wireless or wired second network communication device 33. The wireless or wired network communication device may be a signal transmission device in general, for example, a communication base station or a data switching device. In audio communication, a terminal device serving as a transmit end performs multi-channel encoding on an acquired multi-channel signal, then performs channel encoding, and transmits an encoded signal in a digital channel through a wireless network or a core network. A terminal device serving as a receive end performs channel decoding based on a received signal, to obtain a multi-channel signal encoding bitstream, and then restores a multi-channel signal through multi-channel decoding. The terminal device serving as the receive end performs playback.

FIG. 3b is a schematic diagram of application of a multi-channel encoder to a wireless device or a core network device according to an embodiment of this application. A wireless device or core network device 35 includes: a channel decoder 351, another audio decoder 352, a multi-channel encoder 353, and a channel encoder 354. FIG. 3b is similar to FIG. 2b, and details are not described herein again.

FIG. 3c is a schematic diagram of application of a multi-channel decoder to a wireless device or a core network device according to an embodiment of this application. The wireless device or core network device 35 includes: a channel decoder 351, a multi-channel decoder 355, another audio encoder 356, and a channel encoder 354. FIG. 3c is similar to FIG. 2c, and details are not described herein again.

Audio encoding may be a part of the multi-channel encoder, and audio decoding may be a part of the multi-channel decoder. For example, performing multi-channel encoding on an acquired multi-channel signal may be processing the acquired multi-channel signal to obtain an audio signal. Then, the obtained audio signal is encoded according to the method provided in embodiments of this application. The decoder side encodes a bitstream based on the multi-channel signal, performs decoding, to obtain an audio signal, and restores the multi-channel signal after upmixing processing. Therefore, embodiments of this application may also be applied to a multi-channel encoder and a multi-channel decoder in a terminal device, a wireless device, or a core network device. In the wireless or core network device, if transcoding needs to be implemented, corresponding multi-channel encoding processing needs to be performed.

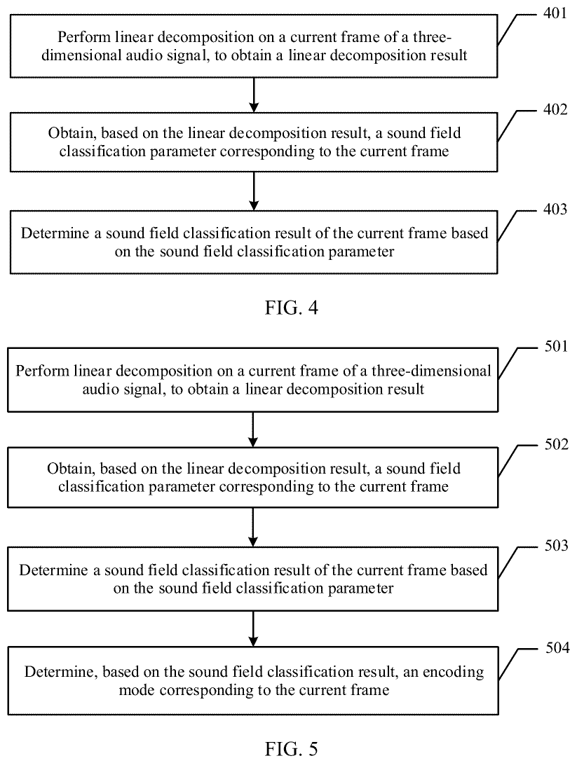

A three-dimensional audio signal processing method provided in embodiments of this application is first described. The method may be performed by a terminal device. For example, the terminal device may be an audio encoding apparatus (which is referred to as an encoder side or an encoder in the following). That the terminal device may alternatively be a three-dimensional audio signal processing apparatus is not limited. As shown in FIG. 4, the three-dimensional audio signal processing method mainly includes the following operations.

401: Perform linear decomposition on a current frame of a three-dimensional audio signal, to obtain a linear decomposition result.

An encoder side may obtain the three-dimensional audio signal. For example, the three-dimensional audio signal may be a scene audio signal. Specifically, the three-dimensional audio signal may be a time domain signal or a frequency domain signal. In addition, the three-dimensional audio signal may alternatively be a signal obtained through downsampling.

In some embodiments of this application, the three-dimensional audio signal includes a higher-order ambisonics HOA signal or a first-order ambisonics FOA signal. That the three-dimensional audio signal may alternatively be another type of signal is not limited. This is merely an example of this application, and is not intended as a limitation on this embodiment of this application.

For example, the three-dimensional audio signal may be a time domain HOA signal or a frequency domain HOA signal. For another example, the three-dimensional audio signal may include all channels of the HOA signal or may include some HOA channels (for example, an FOA channel). In addition, the three-dimensional audio signal may be all sampling points of the HOA signal, or may be 1/Q down-sampling points of a to-be-analyzed HOA signal obtained through downsampling. Q is a down-sampling interval, and 1/Q is a down-sampling rate.

In this embodiment of this application, the three-dimensional audio signal includes a plurality of frames. The following uses processing of one frame of the three-dimensional audio signal as an example. For example, if the frame is the current frame, a previous frame exists before the current frame, and a next frame exists after the current frame of the three-dimensional audio signal. In addition, in this embodiment of this application, a method for processing another frame in the three-dimensional audio signal other than the current frame is similar to a method for processing the current frame. The following uses processing of the current frame as an example.

In this embodiment of this application, after the current frame of the three-dimensional audio signal is obtained, linear decomposition is first performed on the current frame, to obtain the linear decomposition result of the current frame. There are a plurality of linear decomposition manners, which are described in detail below.

In some embodiments of this application, the performing linear decomposition on a current frame of a three-dimensional audio signal, to obtain a linear decomposition result in operation 401 includes:
A1: performing singular value decomposition on the current frame, to obtain a singular value corresponding to the current frame, where the linear decomposition result includes the singular value;
A2: performing principal component analysis on the current frame, to obtain a first feature value corresponding to the current frame, where the linear decomposition result includes the first feature value; or
A3: performing independent component analysis on the current frame, to obtain a second feature value corresponding to the current frame, where the linear decomposition result includes the second feature value.

There are a plurality of linear decomposition manners. For example, linear decomposition may include at least one of the following: singular value decomposition (SVD), principal component analysis (PCA), and independent component analysis (ICA). In different linear decomposition manners, obtained linear decomposition results have different expression manners, which are described in detail below.

In operation A1, linear decomposition may be singular value decomposition. For example, it is assumed that the three-dimensional audio signal is an HOA signal. The HOA signal forms a matrix A, and the matrix A is an L*K matrix, where L is equal to a quantity of channels of the HOA signal, and K is a quantity of signal points of each channel of the HOA signal in the current frame. For example, the quantity of signal points may include: a quantity of frequencies, a quantity of sampling points in time domain, or a quantity of frequencies or a quantity of sampling points after downsampling. Singular value decomposition is performed on the matrix A, and the following relationship is met:

A=UΣV^{T}

U is an L*L matrix, V is a K*K matrix, a superscript T is transposition of the matrix V, and * indicates multiplication. Σ is an L*K diagonal matrix, where each element on a main diagonal of the matrix is a singular value, obtained through singular value decomposition, of the matrix A, and all elements outside the main diagonal are 0. The element, namely, the singular value of the matrix A, on the main diagonal of the diagonal matrix Σ is denoted as v[i], where i0, 1, . . . , min(L, k)−1.

It should be noted that, if the three-dimensional audio signal is an HOA signal obtained through downsampling, K is a quantity of signal points of each channel of the HOA signal in the current frame after downsampling. For example, the quantity of signal points may be a quantity of sampling points or a quantity of frequencies.

In operation A2, linear decomposition may alternatively be principal component analysis, to obtain a feature value. To distinguish from another feature value in subsequent embodiments, the feature value obtained through principal component analysis is defined as the first feature value. A specific implementation of principal component analysis is not described herein again.

In operation A3, linear decomposition may alternatively be independent component analysis, to obtain the second feature value. A specific implementation of independent component analysis is not described herein again.

In this embodiment of this application, linear decomposition of the current frame can be implemented in any one of the foregoing implementations A1 to A3, to obtain a plurality of types of linear decomposition results.

402: Obtain, based on the linear decomposition result, a sound field classification parameter corresponding to the current frame.

After obtaining the linear analysis result of the current frame, the encoder side analyzes the linear decomposition result, to obtain the sound field classification parameter corresponding to the current frame. The sound field classification parameter is obtained by analyzing the linear decomposition result of the current frame, and the sound field classification parameter is used to determine a sound field classification result of the current frame. Based on different specific implementations of the linear decomposition result, the sound field classification parameter may have a plurality of implementations.

In this embodiment of this application, there may be one or more linear decomposition results. For example, the linear decomposition result includes a singular value, the singular value is v[i], and i=0, 1,. . . , min(L, K)−1. When there is only one singular value of the current frame, there is only one value of i, namely, v[0]. When there are a plurality of singular values of the current frame, there are a plurality of values of i, namely, v[i], where i=1, . . . , min(L, K)−1.

In this embodiment of this application, when there are two linear decomposition results, there is one obtained sound field classification parameter. When a quantity of linear decomposition results is N, a quantity of obtained sound field classification parameters is N−1, and a value of N is not limited.

In some embodiments of this application, the obtaining, based on the linear decomposition result, a sound field classification parameter corresponding to the current frame in operation 402 includes:
B1: obtaining a ratio of an i^{th} linear analysis result of the current frame to an (i+1)^{th} linear analysis result of the current frame, where i is a positive integer; and
B2: obtaining, based on the ratio, an i^{th} sound field classification parameter corresponding to the current frame.

The encoder side may obtain, based on the linear decomposition result, the sound field classification parameter corresponding to the current frame. For example, there are a plurality of linear decomposition results of the current frame, and two consecutive linear analysis results in the plurality of linear analysis results are represented as the i^{th} linear analysis result and the (i+1)^{th} linear analysis result of the current frame. In this case, the ratio of the i^{th} linear analysis result of the current frame to the (i+1)^{th} linear analysis result of the current frame may be calculated, and a specific value of i is not limited.

In one embodiment, the i^{th} linear analysis result and the (i+1)^{th} linear analysis result are two consecutive linear analysis results of the current frame.

After the ratio is obtained, the i^{th} sound field classification parameter corresponding to the current frame may be obtained based on the ratio of the i^{th} linear analysis result to the (i+1)^{th} linear analysis result of the current frame. It can be learned that the i^{th} sound field classification parameter can be calculated based on the ratio of the i^{th} linear analysis result to the (i+1)^{th} linear analysis result. An (i+1)^{th} sound field classification parameter may be calculated based on a ratio of the (i+1)^{th} linear analysis result to an (i+2)^{th} linear analysis result, and the rest can be deduced by analogy. There is a correspondence between the linear analysis result and the sound field classification parameter.

In an implementation, a ratio of the i^{th} linear analysis result to the (i+1)^{th} linear analysis result may be used as the i^{th} sound field classification parameter. After the ratio of the i^{th} linear analysis result to the (i+1)^{th} linear analysis result is obtained, that a plurality of calculation manners may further be performed on the ratio is not limited, so that the i^{th} sound field classification parameter may be calculated. For example, a multiplication operation is performed on the ratio based on a preset adjustment factor, to obtain the i^{th} sound field classification parameter.

For example, if singular value decomposition is used for linear decomposition, a singular value may be obtained based on the sound field classification parameter through singular value decomposition, and a ratio parameter between two adjacent singular values is calculated, and used as the sound field classification parameter.

For example, a ratio temp[i] between singular values is calculated, and used as the sound field classification parameter. For i=0, 1, min(L, K)−2, temp[i] meets:

temp[i]=v[i]/v[i+1].

If PCA or ICA is used for linear decomposition, the sound field classification parameter may be determined based on a feature value. A method for calculating the sound field classification parameter is similar to a method for calculating the ratio temp between singular values. Alternatively, a ratio between two consecutive feature values may be calculated based on feature values obtained through linear decomposition, and the ratio is used as the sound field classification parameter.

It should be noted that, if a quantity of feature values or singular values obtained through linear decomposition is greater than 2, the sound field classification parameter is a vector. If a quantity of feature values or singular values obtained through linear decomposition is not greater than 2 the sound field classification parameter is a scalar. For example, for v[i], if the value of i is equal to 2, the calculated temp[i] is a scalar, that is, there is only one temp value. For v[i], if the value of i is greater than 2, the calculated temp[i] is a vector, and temp includes at least two elements.

403: Determine a sound field classification result of the current frame based on the sound field classification parameter.

In this embodiment of this application, after obtaining the sound field classification parameter corresponding to the current frame, the encoder side may perform sound field classification on the current frame based on the sound field classification parameter. Because the sound field classification parameter corresponding to the current frame may indicate a parameter required for classification of a sound field corresponding to the current frame, the sound field classification result of the current frame may be obtained based on the sound field classification parameter.

In some embodiments of this application, the sound field classification result may include at least one of the following: a sound field type and a quantity of heterogeneous sound sources.

The sound field type is a sound field type that is of the current frame and that is determined after sound field classification is performed on the current frame. There are a plurality of manners of classifying sound field types. For example, the sound field types may be classified into a first sound field type and a second sound field type. Alternatively, the sound field types may be classified into a first sound field type, a second sound field type, a third sound field type, and the like. Specifically, a quantity of sound field types that can be classified may be determined based on an application scenario. For another example, the sound field type may include a heterogeneous sound field and a dispersive sound field. The heterogeneous sound field means that point sound sources with different positions and/or directions exist in the sound field, and the dispersive sound field is a sound field that does not include a heterogeneous sound source. For example, point sound sources with different positions and/or directions are heterogeneous sound sources, a sound field including a heterogeneous sound source is a heterogeneous sound field, and a sound field that does not include a heterogeneous sound source is a dispersive sound field.

The heterogeneous sound sources are point sound sources with different positions and/or directions, and the quantity of heterogeneous sound sources included in the current frame is referred to as a quantity of heterogeneous sound sources. The sound field of the current frame can alternatively be classified based on the quantity of heterogeneous sound sources.

In some embodiments of this application, there are a plurality of sound field classification parameters. The sound field classification result includes a sound field type.

The determining a sound field classification result of the current frame based on the sound field classification parameter in operation 403 includes:
when values of the plurality of sound field classification parameters all meet a preset dispersive sound source decision condition, determining that the sound field type is a dispersive sound field; or
when at least one of values of the plurality of sound field classification parameters meets a preset heterogeneous sound source decision condition, determining that the sound field type is a heterogeneous sound field.

The sound field type may include a heterogeneous sound field and a dispersive sound field. In this embodiment of this application, the dispersive sound source decision condition and the heterogeneous sound source decision condition are preset. The dispersive sound source decision condition is used to determine whether the sound field type is a dispersive sound field, and the heterogeneous sound source decision condition is used to determine whether the sound field type is a heterogeneous sound field. After the plurality of sound field classification parameters of the current frame are obtained, determining is performed based on the values of the plurality of sound field classification parameters and the preset condition. Specific implementations of the dispersive sound source decision condition and the heterogeneous sound source decision condition are not limited herein.

After the plurality of sound field classification parameters are obtained, when values of the plurality of sound field classification parameters all meet a preset dispersive sound source decision condition, the encoder side determines that the sound field type is a dispersive sound field. For example, the current frame corresponds to N sound field classification parameters. Only when values of the N sound field classification parameters all meet the preset dispersive sound source decision condition, it is determined that the sound field type of the current frame is a dispersive sound field.

After the plurality of sound field classification parameters are obtained, when at least one of values of the plurality of sound field classification parameters meets the preset heterogeneous sound source decision condition, the encoder side determines that the sound field type is a heterogeneous sound field. For example, the current frame corresponds to N sound field classification parameters. Only when at least one of values of the N sound field classification parameters meets the preset heterogeneous sound source decision condition, it is determined that the sound field type is a heterogeneous sound field.

Further, in some embodiments of this application, the dispersive sound source decision condition includes that the value of the sound field classification parameter is less than a preset heterogeneous sound source determining threshold; or
the heterogeneous sound source decision condition includes that the value of the sound field classification parameter is greater than or equal to a preset heterogeneous sound source determining threshold.

The heterogeneous sound source determining threshold may be a preset threshold, and a specific value is not limited. The dispersive sound source decision condition includes that the value of the sound field classification parameter is less than the preset heterogeneous sound source determining threshold. Therefore, when the values of the plurality of sound field classification parameters are all less than the preset heterogeneous sound source determining threshold, it is determined that the sound field type is the dispersive sound field. The heterogeneous sound source decision condition includes that the value of the sound field classification parameter is greater than or equal to the preset heterogeneous sound source determining threshold. Therefore, when at least one of the values of the plurality of sound field classification parameters is greater than or equal to the preset heterogeneous sound source determining threshold, it is determined that the sound field type is the heterogeneous sound field.

In some embodiments of this application, there are a plurality of sound field classification parameters.

The sound field classification result includes a sound field type, or the sound field classification result includes a quantity of heterogeneous sound sources and a sound field type.

The determining a sound field classification result of the current frame based on the sound field classification parameter in operation 403 includes:
C1: obtaining, based on values of the plurality of sound field classification parameters, a quantity of heterogeneous sound sources corresponding to the current frame; and
C2: determining the sound field type based on the quantity of heterogeneous sound sources corresponding to the current frame.

After obtaining the plurality of sound field classification parameters corresponding to the current frame, the encoder side may obtain, based on the values of the plurality of sound field classification parameters, the quantity of heterogeneous sound sources corresponding to the current frame. The heterogeneous sound sources are point sound sources with different positions and/or directions, and the quantity of heterogeneous sound sources included in the current frame is referred to as a quantity of heterogeneous sound sources. The sound field of the current frame can be classified based on the quantity of heterogeneous sound sources. After the quantity of heterogeneous sound sources corresponding to the current frame is obtained to determine the sound field type, the sound field type corresponding to the current frame may be determined by analyzing the quantity of heterogeneous sound sources corresponding to the current frame.

In some embodiments of this application, there are a plurality of sound field classification parameters.

The sound field classification result includes a quantity of heterogeneous sound sources.

The determining a sound field classification result of the current frame based on the sound field classification parameter in operation 403 includes:
D1: obtaining, based on values of the plurality of sound field classification parameters, a quantity of heterogeneous sound sources corresponding to the current frame.

After obtaining the plurality of sound field classification parameters corresponding to the current frame, the encoder side may obtain, based on the values of the plurality of sound field classification parameters, the quantity of heterogeneous sound sources corresponding to the current frame. The heterogeneous sound sources are point sound sources with different positions and/or directions, and the quantity of heterogeneous sound sources included in the current frame is referred to as a quantity of heterogeneous sound sources.

Further, in some embodiments of this application, the plurality of sound field classification parameters are temp[i], i=0, 1, . . . , min(L, K)−2, L indicates a quantity of channels of the current frame, K is a quantity of signal points corresponding to each channel of the current frame, and min indicates an operation in which a minimum value is selected. For example, the quantity of signal points may be a quantity of frequencies, a quantity of sampling points in time domain, or a quantity of frequencies or a quantity of sampling points in time domain after downsampling.

The obtaining, based on values of the plurality of sound field classification parameters, a quantity of heterogeneous sound sources corresponding to the current frame in operation C1 or operation D1 includes:
sequentially performing the following determining procedures from i=0:
determining whether temp[i] is greater than a preset heterogeneous sound source determining threshold; and
when temp[i] is less than the heterogeneous sound source determining threshold in this determining procedure, updating a value of i to i+1, and continuing to perform a next determining procedure; or
when temp[i] is greater than or equal to the heterogeneous sound source determining threshold in this determining procedure, terminating execution of the determining procedure, and determining that i in this determining procedure plus 1 is equal to the quantity of heterogeneous sound sources.

Specifically, the encoder side may estimate the quantity of heterogeneous sound sources based on the sound field classification parameter, and determine the sound field type.

The sound field type may include a heterogeneous sound field and a dispersive sound field. The heterogeneous sound field means that point sound sources with different positions and/or directions exist in the sound field. The dispersive sound field is a sound field that does not include a heterogeneous sound source.

If values of the sound field classification parameters all meet the dispersive sound source decision condition, the sound field type is a dispersive sound field.

When a value of the sound field classification parameters meets the heterogeneous sound source decision condition, it is determined that the sound field type is a heterogeneous sound field. The quantity of heterogeneous sound sources may be estimated based on a sequence number of a value, in the values of the sound field classification parameters, that meets the heterogeneous sound source decision condition.

For example, when the ratio temp[i] between the singular values is used as the sound field classification parameter, the sound field type and the quantity of heterogeneous sound sources are estimated based on the sound field classification parameter, and the value of temp[i] are sequentially determined from i=0. When the value of i is m, a value of an m^{th} sound field classification parameter is represented as temp[m]. When the m^{th} sound field classification parameter meets temp[m]≥TH1, the sound field type is a heterogeneous sound field, and there are (m+1) heterogeneous sound sources in the sound field of the current frame. If temp[m]≥TH1 is not met, the sound field type is a dispersive sound field. A value range of m is [0, 1, . . . , min(L, K)−2], TH1 is the preset heterogeneous sound source determining threshold, and a value of TH1 may be a constant, for example, the value of TH1 may be 30 or 100. The value of TH1 is not limited in this embodiment of this application.

In some embodiments of this application, the determining the sound field type based on the quantity of heterogeneous sound sources corresponding to the current frame in operation C2 includes:
when the quantity of heterogeneous sound sources meets a first preset condition, determining that the sound field type is a first sound field type; or
when the quantity of heterogeneous sound sources does not meet a first preset condition, determining that the sound field type is a second sound field type.

A quantity of heterogeneous sound sources corresponding to the first sound field type is different from a quantity of heterogeneous sound sources corresponding to the second sound field type.

Specifically, sound field types may be classified into two types based on different quantities of heterogeneous sound sources: the first sound field type and the second sound field type. The encoder side Obtains the first preset condition; determines whether the quantity of heterogeneous sound sources meets the first preset condition; and when the quantity of heterogeneous sound sources meets the first preset condition, determines that the sound field type is the first sound field type; or when the quantity of heterogeneous sound sources does not meet the first preset condition, determines that the sound field type is the second sound field type. In this embodiment of this application, whether the quantity of heterogeneous sound sources meets the first preset condition may be determined, to implement division of the sound field type of the current frame, to accurately identify that the sound field type of the current frame belongs to the first sound field type or the second sound field type.

In some embodiments of this application, the first preset condition includes that the quantity of heterogeneous sound sources is greater than a first threshold or less than a second threshold, and the second threshold is greater than the first threshold; or
the first preset condition includes that the quantity of heterogeneous sound sources is not greater than a first threshold or not less than a second threshold, and the second threshold is greater than the first threshold.

Specific values of the first threshold and the second threshold are not limited, and may be specifically determined based on an application scenario. The second threshold is greater than the first threshold. Therefore, the first threshold and the second threshold may form a preset range, and the first preset condition may be that the quantity of heterogeneous sound sources falls within the preset range, or the first preset condition may be that the quantity of heterogeneous sound sources is beyond the preset range. The quantity of heterogeneous sound sources may be determined based on the first threshold and the second threshold in the first preset condition, to determine whether the quantity of heterogeneous sound sources meets the first preset condition, to accurately identify that the sound field type of the current frame belongs to the first sound field type or the second sound field type.

For example, the first threshold is 0, the second threshold is 3, and the quantity of heterogeneous sound sources is represented as n. In this case, the first preset condition may be 0<n<3, or the first preset condition may be n≥3 or n=0.

In some embodiments of this application, the determining a sound field classification result of the current frame based on the sound field classification parameter may further include: determining the sound field classification result of the current frame based on the sound field classification parameter and another parameter indicating a feature of the three-dimensional audio signal.

There are a plurality of implementations of the another parameter indicating the feature of the three-dimensional audio signal. For example, the another parameter indicating the feature of the three-dimensional audio signal may include at least one of the following: an energy ratio parameter of the three-dimensional audio signal, a high-frequency analysis parameter of the three-dimensional audio signal, a low-frequency feature analysis parameter of the three-dimensional audio signal, and the like.

As shown in FIG. 5, a three-dimensional audio signal processing method according to an embodiment of this application mainly includes the following operations.

501: Perform linear decomposition on a current frame of a three-dimensional audio signal, to obtain a linear decomposition result.

502: Obtain, based on the linear decomposition result, a sound field classification parameter corresponding to the current frame.

503: Determine a sound field classification result of the current frame based on the sound field classification parameter.

Implementations of operation 501 to operation 503 are similar to implementations of operation 401 to operation 403 in the foregoing embodiment, and operation 501 to operation 503 are not described in detail herein again.

504: Determine, based on the sound field classification result, an encoding mode corresponding to the current frame.

An encoder side may perform operation 501 to operation 503. After obtaining the sound field classification result of the current frame, the encoder side may determine, based on the sound field classification result, the encoding mode corresponding to the current frame. The encoding mode is a mode used when the current frame of the three-dimensional audio signal is encoded. There are a plurality of encoding modes, and different encoding modes may be used based on different sound field classification results of the current frame. In this embodiment of this application, appropriate encoding modes are selected for different sound field classification results of the current frame, so that the current frame is encoded by using the encoding mode. This improves compression efficiency and auditory quality of an audio signal.

Further, in some embodiments of this application, the determining, based on the sound field classification result, an encoding mode corresponding to the current frame in operation 504 includes:
E1: when the sound field classification result includes the quantity of heterogeneous sound sources, or the sound field classification result includes the quantity of heterogeneous sound sources and the sound field type, determining, based on the quantity of heterogeneous sound sources, the encoding mode corresponding to the current frame;
E2: when the sound field classification result includes the sound field type, or the sound field classification result includes the quantity of heterogeneous sound sources and the sound field type, determining, based on the sound field type, the encoding mode corresponding to the current frame; or
E3: when the sound field classification result includes the quantity of heterogeneous sound sources and the sound field type, determining, based on the quantity of heterogeneous sound sources and the sound field type, the encoding mode corresponding to the current frame.

In operation E1, after the encoder side obtains the quantity of heterogeneous sound sources of the current frame, the quantity of heterogeneous sound sources may be used to determine the encoding mode corresponding to the current frame. In operation E2, after the encoder side obtains the sound field type of the current frame, the sound field type may be used to determine the encoding mode corresponding to the current frame. In operation E3, after the encoder side obtains the quantity of heterogeneous sound sources and the sound field type, the quantity of heterogeneous sound sources and the sound field type may be used to determine the encoding mode corresponding to the current frame. Therefore, the encoder side may determine, based on the quantity of heterogeneous sound sources and/or the sound field type, the encoding mode corresponding to the current frame, to determine a corresponding encoding mode based on the sound field classification result of the current frame, so that the determined encoding mode can be adapted to the current frame of the three-dimensional audio signal. This improves encoding efficiency.

Further, in some embodiments of this application, the determining, based on the quantity of heterogeneous sound sources, the encoding mode corresponding to the current frame in operation E1 includes:
when the quantity of heterogeneous sound sources meets a second preset condition, determining that the encoding mode is a first encoding mode; or
when the quantity of heterogeneous sound sources does not meet a second preset condition, determining that the encoding mode is a second encoding mode.

The first encoding mode is an HOA encoding mode based on virtual speaker selection or an HOA encoding mode based on directional audio coding, the second encoding mode is an HOA encoding mode based on virtual speaker selection or an HOA encoding mode based on directional audio coding, and the first encoding mode and the second encoding mode are different encoding modes. The HOA encoding mode based on virtual speaker selection may also be referred to as an HOA encoding mode based on match projection (MP).

Specifically, encoding modes may be classified into two types based on different quantities of heterogeneous sound sources: the first encoding mode and the second encoding mode. The encoder side obtains the second preset condition; determines whether the quantity of heterogeneous sound sources meets the second preset condition; and when the quantity of heterogeneous sound sources meets the second preset condition, determines that the encoding mode is the first encoding mode; or when the quantity of heterogeneous sound sources does not meet the second preset condition, determines that the encoding mode is the second encoding mode. In this embodiment of this application, whether the quantity of heterogeneous sound sources meets the second preset condition may be determined, to implement division of the encoding mode of the current frame, to accurately identify that the encoding mode of the current frame belongs to the first encoding mode or the second encoding mode.

For example, when the first encoding mode is the HOA encoding mode based on virtual speaker selection, the second encoding mode is the HOA encoding mode based on directional audio coding. Alternatively, when the first encoding mode is the HOA encoding mode based on directional audio coding, the second encoding mode is the HOA encoding mode based on virtual speaker selection, and specific implementations of the first encoding mode and the second encoding mode may be determined based on an application scenario.

For example, in this embodiment of this application, the sound field classification result may be used to determine the encoding mode selected by the encoder side. For example, the sound field classification result may be used to determine an encoding mode of an HOA signal. For example, the encoding mode is determined based on the sound field type. An HOA signal belonging to a heterogeneous sound field is suitable for encoding by using an encoder corresponding to an encoding mode A, and an HOA signal belonging to a dispersive sound field is suitable for encoding by using an encoder corresponding to an encoding mode B. For another example, the encoding mode is determined based on the quantity of heterogeneous sound sources. When the quantity of heterogeneous sound sources meets a decision condition for using an encoding mode X, encoding is performed by using an encoder corresponding to the encoding mode X. For another example, the encoding mode is alternatively determined based on the sound field type and the quantity of heterogeneous sound sources. When the sound field type is a dispersive sound field, encoding is performed by using an encoder corresponding to an encoding mode C. When the sound field type is a heterogeneous sound field and the quantity of heterogeneous sound sources meets a decision condition of using an encoding mode X, encoding is performed by using an encoder corresponding to the encoding mode X. The encoding mode A, the encoding mode B, the encoding mode C, and the encoding mode X may include a plurality of different encoding modes. In this embodiment of this application, different sound field classification results correspond to different encoding modes. This is not limited in this embodiment of this application. For example, the encoding mode X may be an encoding mode 1 when the quantity of heterogeneous sound sources is less than a preset threshold, or an encoding mode 2 when the quantity of heterogeneous sound sources is greater than or equal to a preset threshold.

In some embodiments of this application, the second preset condition includes that the quantity of heterogeneous sound sources is greater than a first threshold or less than a second threshold, and the second threshold is greater than the first threshold; or
the second preset condition includes that the quantity of heterogeneous sound sources is not greater than a first threshold or not less than a second threshold, and the second threshold is greater than the first threshold.

Specific values of the first threshold and the second threshold are not limited, and may be specifically determined based on an application scenario. The second threshold is greater than the first threshold. Therefore, the first threshold and the second threshold may form a preset range, and the second preset condition may be that the quantity of heterogeneous sound sources falls within the preset range, or the second preset condition may be that the quantity of heterogeneous sound sources is beyond the preset range. The quantity of heterogeneous sound sources may be determined based on the second threshold and the second threshold in the first preset condition, to determine whether the quantity of heterogeneous sound sources meets the second preset condition, to accurately identify that the sound field type of the current frame belongs to the first sound field type or the second sound field type.

For example, the first threshold is 0, the second threshold is 3, and the quantity of heterogeneous sound sources is represented as n. In this case, the second preset condition may be 0<n<3, or the second preset condition may be n≥3 or n=0.

It should be noted that in this embodiment of this application, the first preset condition is a condition set for identifying different sound field types, and the second preset condition is a condition set for identifying different encoding modes. The first preset condition and the second preset condition may include same condition content or different condition content. In other words, the first preset condition and the second preset condition may be different preset conditions or a same preset condition. However, it is considered that there may be differences during actual usage. The first preset condition and the second preset condition are distinguished by using numbers of first and second.

In some embodiments of this application, the determining, based on the sound field type, an encoding mode corresponding to the current frame in operation E2 includes:
when the sound field type is a heterogeneous sound field, determining that the encoding mode is the HOA encoding mode based on virtual speaker selection; or
when the sound field type is a dispersive sound field, determining that the encoding mode is the HOA encoding mode based on directional audio coding.

For a sound field in which there are few heterogeneous sound sources in the sound field and for a dispersive sound field, the HOA encoding mode based on directional audio coding has lower compression efficiency than the HOA encoding mode based on virtual speaker selection. However, for a sound field in which there are a plurality of heterogeneous sound sources in the sound field, the HOA encoding mode based on virtual speaker selection has lower compression efficiency than the HOA encoding mode based on direction audio coding. In this embodiment of this application, when the sound field type is a heterogeneous sound field, it is determined that the encoding mode is the HOA encoding mode based on virtual speaker selection. When the sound field type is a dispersive sound field, it is determined that the encoding mode is the HOA encoding mode based on direction audio coding. In this embodiment of this application, a corresponding encoding mode may be selected based on the sound field classification result of the current frame, to meet a requirement of obtaining maximum compression efficiency for different types of audio signals.

In some embodiments of this application, the determining, based on the sound field classification result, an encoding mode corresponding to the current frame in operation 503 includes:
F1: determining, based on the sound field classification result of the current frame, an initial encoding mode corresponding to the current frame;
F2: obtaining a hangover (hangover) window in which the current frame is located, where the hangover window includes the initial encoding mode of the current frame and encoding modes of N−1 frames before the current frame, N is a length of the hangover window; and
F3: determining the encoding mode of the current frame based on the initial encoding mode of the current frame and the encoding modes of the N−1 frames.

In operation F1, the initial encoding mode may be an encoding mode determined based on the sound field classification result. For example, the encoding mode of the current frame may be determined based on any one of the foregoing implementations in operation E1 to operation E3, and the encoding mode may be used as the initial encoding mode in F1. After the initial encoding mod is obtained, the hangover window is obtained based on the current frame and a window size of the hangover window. The hangover window includes the initial encoding mode of the current frame and the encoding modes of the N−1 frames before the current frame, and N indicates a quantity of frames included in the hangover window. Finally, the encoding mode of the current frame is determined based on encoding modes separately corresponding to N frames in the hangover window. The encoding mode of the current frame obtained in operation F3 may be an encoding mode used when the current frame is encoded. In this embodiment of this application, the initial encoding mode of the current frame is corrected based on the hangover window, to obtain the encoding mode of the current frame. This ensures that encoding modes of consecutive frames are not frequently switched, and improves encoding efficiency.

For example, after the initial encoding mode of the current frame is obtained, hangover window processing may be performed on the current frame, to ensure that encoding modes of consecutive frames are not frequently switched. There are a plurality of hangover window processing methods. This is not limited in this embodiment of this application. For example, a processing manner may be storing an encoder selection identifier whose length is N frames in the hangover window where the N frames include encoder selection identifiers of the current frame and N−1 frames before the current frame; and when encoder selection identifiers are accumulated to a specified threshold, updating an encoding type indication identifier of the current frame. In one embodiment, in addition to hangover window processing, other post-processing may be used to perform correction on the current frame. For example, the initial encoding mode is used as initial classification, the initial classification is modified based on features such as a speech classification result and a signal-to-noise ratio of the audio signal, and a modified result is used as a final result of the encoding mode.

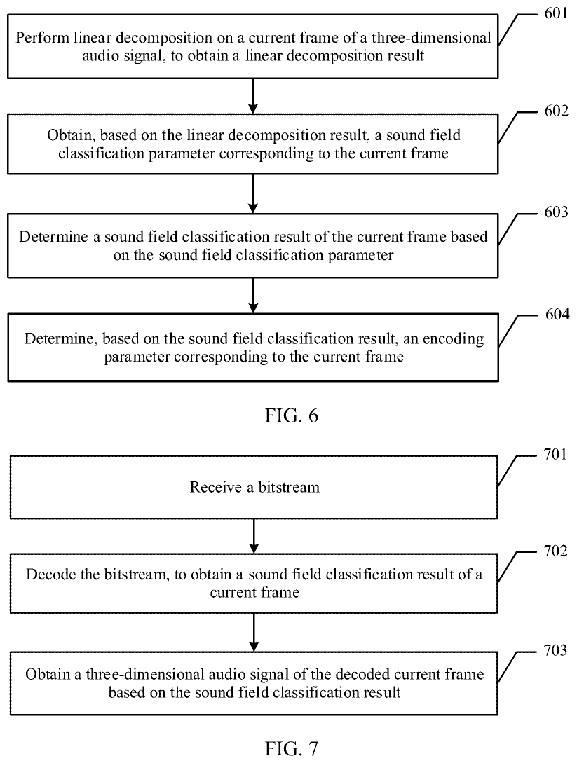

As shown in FIG. 6, a three-dimensional audio signal processing method according to an embodiment of this application mainly includes the following operations.

601: Perform linear decomposition on a current frame of a three-dimensional audio signal, to obtain a linear decomposition result.

602: Obtain, based on the linear decomposition result, a sound field classification parameter corresponding to the current frame.

603: Determine a sound field classification result of the current frame based on the sound field classification parameter.

Implementations of operation 601 to operation 603 are similar to implementations of operation 401 to operation 403 in the foregoing embodiment, and operation 601 to operation 603 are not described in detail herein again.

604: Determine, based on the sound field classification result, an encoding parameter corresponding to the current frame.

An encoder side may perform operation 601 to operation 603. After obtaining the sound field classification result of the current frame, the encoder side may determine, based on the sound field classification result, the encoding parameter corresponding to the current frame. The encoding parameter is a parameter used when the current frame of the three-dimensional audio signal is encoded. There are a plurality of encoding parameters, and different encoding parameters may be used based on different sound field classification results of the current frame. In this embodiment of this application, appropriate encoding parameters are selected for different sound field classification results of the current frame, so that the current frame is encoded based on the encoding parameter. This improves compression efficiency and auditory quality of an audio signal.

Further, in some embodiments of this application, the encoding parameter includes at least one of the following: a quantity of channels of a virtual speaker signal, a quantity of channels of a residual signal, a quantity of encoding bits of a virtual speaker signal, a quantity of encoding bits of a residual signal, or a quantity of voting rounds for searching for a best matching speaker.

The virtual speaker signal and the residual signal are signals generated based on the three-dimensional audio signal.

Specifically, the encoder side may determine the encoding parameter of the current frame based on the sound field classification result of the current frame, so that the encoding parameter may be used to encode the current frame. There are a plurality of implementations for the encoding parameter. For example, the encoding parameter includes at least one of the following: a quantity of channels of a virtual speaker signal, a quantity of channels of a residual signal, a quantity of encoding bits of a virtual speaker signal, a quantity of encoding bits of a residual signal, or a quantity of voting rounds for searching for a best matching speaker. The quantity of channels may also be referred to as a quantity of transmission channels. The quantity of channels is a quantity of transmission channels allocated during signal encoding, and the quantity of encoding bits is a quantity of encoding bits allocated during signal encoding.

In a method for selecting a virtual speaker provided in this embodiment of this application, an encoder votes on each virtual speaker in a candidate virtual speaker set based on a virtual speaker coefficient of the current frame, and selects a virtual speaker of the current frame based on a voting value, to reduce calculation responsibility for searching for a virtual speaker, and reduce a calculation burden of the encoder. A quantity of voting rounds for searching for a best matching speaker is a quantity of voting rounds required in searching for the best matching speaker. In one embodiment, the quantity of voting rounds may be pre-configured, or may be determined based on the sound field classification result of the current frame. For example, the quantity of voting rounds for searching for the best matching speaker is a quantity of voting rounds for searching for the virtual speaker in a process of determining a virtual speaker signal based on the three-dimensional audio signal.

In addition, the virtual speaker signal and the residual signal in this embodiment of this application are signals generated based on the three-dimensional audio signal. For example, a first target virtual speaker is selected from a preset virtual speaker set based on a first scene audio signal, and the virtual speaker signal is generated based on the first scene audio signal and attribute information of the first target virtual speaker. A second scene audio signal is obtained based on the attribute information of the first target virtual speaker and a first virtual speaker signal, and a residual signal is generated based on the first scene audio signal and the second scene audio signal.

In some embodiments of this application, the quantity of voting rounds meets the following relationship:

1≤I≤d.

I is the quantity of voting rounds, and d is the quantity of heterogeneous sound sources included in the sound field classification result.

The encoder side determines, based on the quantity of heterogeneous sound sources of the current frame, the quantity of voting rounds for searching for the best matching speaker. The quantity of voting rounds is less than or equal to the quantity of heterogeneous sound sources of the current frame, so that the quantity of voting rounds can comply with an actual situation of sound field classification of the current frame. This resolves a problem that the quantity of voting rounds for searching for the best matching speaker needs to be determined when the current frame is encoded.

For example, the quantity I of voting rounds needs to comply with the following rules: a minimum quantity of voting rounds is one, a maximum quantity of voting rounds does not exceed a total quantity of speakers, and the maximum quantity of voting rounds does not exceed the quantity of channels of the virtual speaker signal. For example, the total quantity of speakers may be 1024 speakers obtained by a virtual speaker set generation unit in the encoder, and the quantity of channels of the virtual speaker signal is a quantity of virtual speaker signals transmitted by the encoder, namely, N transmission channels correspondingly generated by N best matching speakers. Usually, the quantity of channels of the virtual speaker signal is less than the total quantity of speakers. A method for estimating the quantity of voting rounds is as follows: determining, based on the quantity of heterogeneous sound sources, obtained in the sound field classification result, in the sound field of the current frame, the quantity I of voting rounds for searching for the best matching speaker. The quantity I of voting rounds meets the following relationship: 1≥I≥d. d is a quantity of sound sources in different directions included in the sound field, namely, a quantity of estimated heterogeneous sound sources in the sound field classification result. For example, I=d. Alternatively, the quantity of voting rounds I=min(d, the total quantity of speakers, the quantity of channels of the virtual speaker signal, a preset quantity of voting rounds). The quantity I of voting rounds may be obtained based on min(d, the total quantity of speakers, the quantity of channels of the virtual speaker signal, the preset quantity of voting rounds), so that the encoder side may determine, based on a value of I, the quantity of voting rounds for searching for the best matching speaker.

In some embodiments of this application, the sound field classification result includes the quantity of heterogeneous sound sources and the sound field type.

When the sound field type is a heterogeneous sound field, the quantity of channels of the virtual speaker signal meets the following relationship:

F=min(S, PF), where
F is the quantity of channels of the virtual speaker signal, S is the quantity of heterogeneous sound sources, and PF is a quantity of channels of the virtual speaker signal preset by an encoder; or
when the sound field type is a dispersive sound field, the quantity of channels of the virtual speaker signal meets the following relationship:

F=1 where
F is the quantity of channels of the virtual speaker signal.

The quantity of channels of the virtual speaker signal is a quantity of channels for transmitting the virtual speaker signal, and the quantity of channels of the virtual speaker signal may be determined based on the quantity of heterogeneous sound sources and the sound field type. In the foregoing calculation manner, when the sound field type is a dispersive sound field, it is determined that the quantity of channels of the virtual speaker signal is 1, to improve encoding efficiency of the current frame. When the sound field type is a heterogeneous sound field, min indicates an operation in which a minimum value is selected, that is, selecting a minimum value from S and PF as the quantity of channels of the virtual speaker signal, so that the quantity of channels of the virtual speaker signal can comply with an actual situation of sound field classification of the current frame. This resolves a problem that the quantity of channels of the virtual speaker signal needs to be determined when the current frame is encoded.

In some embodiments of this application, when the sound field type is a dispersive sound field, the quantity of channels of the residual signal meets the following relationship:

R=max(C−1, PR), where
PR is a quantity of channels of the residual signal preset by the encoder, and C is a sum of the quantity of channels of the residual signal preset by the encoder and the quantity of channels of the virtual speaker signal preset by the encoder; or
when the sound field type is a heterogeneous sound field, the quantity of channels of the residual signal meets the following relationship:

R=C−F, where
R is the quantity of channels of the residual signal, C is a sum of a quantity of channels of the residual signal preset by the encoder and the quantity of channels of the virtual speaker signal preset by the encoder, and F is the quantity of channels of the virtual speaker signal.

After the quantity of channels of the virtual speaker signal is obtained, the quantity of channels of the residual signal may be calculated based on the preset quantity of channels of the residual signal and the sum of the preset quantity of channels of the residual signal and the preset quantity of channels of the virtual speaker signal. A value of PR may be preset at the encoder side, and a value of R may be obtained according to the formula for calculating max(C−1, PR). The sum of the preset quantity of channels of the residual signal and the preset quantity of channels of the virtual speaker signal is preset at the encoder side. In addition, C may also be referred to as a total quantity of transmission channels.

In some embodiments of this application, after the quantity of channels of the virtual speaker signal is obtained, the quantity of channels of the residual signal may be calculated based on the quantity of channels of the virtual speaker signal and the sum of the preset quantity of channels of the residual signal and the preset quantity of channels of the virtual speaker signal. The sum of the preset quantity of channels of the residual signal and the preset quantity of channels of the virtual speaker signal is preset at the encoder side. In addition, C may also be referred to as a total quantity of transmission channels.

In some embodiments of this application, the sound field classification result includes the quantity of heterogeneous sound sources.

The quantity of channels of the virtual speaker signal meets the following relationship:

F=min(S, PF), where
F is the quantity of channels of the virtual speaker signal, S is the quantity of heterogeneous sound sources, and PF is a quantity of channels of the virtual speaker signal preset by the encoder.

The quantity of channels of the virtual speaker signal is a quantity of channels for transmitting the virtual speaker signal, and the quantity of channels of the virtual speaker signal may be determined based on the quantity of heterogeneous sound sources. In the foregoing calculation manner, min indicates an operation in which a minimum value is selected, that is, selecting a minimum value from S and PF as the quantity of channels of the virtual speaker signal, so that the quantity of channels of the virtual speaker signal can comply with an actual situation of sound field classification of the current frame. This resolves a problem that the quantity of channels of the virtual speaker signal needs to be determined when the current frame is encoded.

In some embodiments of this application, the quantity of channels of the residual signal meets the following relationship:

R=C−F, where
R is the quantity of channels of the residual signal, C is a sum of a quantity of channels of the residual signal preset by the encoder and the quantity of channels of the virtual speaker signal preset by the encoder, and F is the quantity of channels of the virtual speaker signal. For example, C is a sum of PF and PR.

After the quantity of channels of the virtual speaker signal is obtained, the quantity of channels of the residual signal may be calculated based on the quantity of channels of the virtual speaker signal and the sum of the preset quantity of channels of the residual signal and the preset quantity of channels of the virtual speaker signal. The sum of the preset quantity of channels of the residual signal and the preset quantity of channels of the virtual speaker signal is preset at the encoder side. In addition, C may also be referred to as a total quantity of transmission channels.

In some embodiments of this application, the sound field classification result includes the quantity of heterogeneous sound sources, or the sound field classification result includes the quantity of heterogeneous sound sources and the sound field type.

The quantity of encoding bits of the virtual speaker signal is obtained based on a ratio of the quantity of encoding bits of the virtual speaker signal to a quantity of encoding bits of a transmission channel.

The quantity of encoding bits of the residual signal is obtained based on the ratio of the quantity of encoding bits of the virtual speaker signal to the quantity of encoding bits of the transmission channel.

The quantity of encoding bits of the transmission channel includes the quantity of encoding bits of the virtual speaker signal and the quantity of encoding bits of the residual signal, and when the quantity of heterogeneous sound sources is less than or equal to the quantity of channels of the virtual speaker signal, the ratio of the quantity of encoding bits of the virtual speaker signal to the quantity of encoding bits of the transmission channel is obtained by increasing an initial ratio of the quantity of encoding bits of the virtual speaker signal to the quantity of encoding bits of the transmission channel.

The encoder side presets the initial ratio of the quantity of encoding bits of the virtual speaker signal to the quantity of encoding bits of the transmission channel, obtains the quantity of heterogeneous sound sources, and determines whether the quantity of heterogeneous sound sources is less than or equal to the quantity of channels of the virtual speaker signal. If the quantity of heterogeneous sound sources is less than or equal to the quantity of channels of the virtual speaker signal, the initial ratio of the quantity of encoding bits of the virtual speaker signal to the quantity of encoding bits of the transmission channel may be increased, and an increased initial ratio is defined as a ratio of the quantity of encoding bits of the virtual speaker signal to the quantity of encoding bits of the transmission channel. The ratio of the quantity of encoding bits of the virtual speaker signal to the quantity of encoding bits of the transmission channel may be used to calculate the quantity of encoding bits of the virtual speaker signal and the quantity of encoding bits of the residual signal. In the foregoing calculation manner, the quantity of encoding bits of the virtual speaker signal and the quantity of encoding bits of the residual signal can comply with an actual situation of sound field classification of the current frame. This resolves a problem that the quantity of encoding bits of the virtual speaker signal and the quantity of encoding bits of the residual signal needs to be determined when the current frame is encoded.

For example, the encoder side determines a bit allocation method for the virtual speaker signal and the residual signal based on the sound field classification result, divides a transmission channel signal into a virtual speaker signal group and a residual signal group, and uses a preset allocation proportion of the virtual speaker signal group as the initial ratio of the quantity of encoding bits of the virtual speaker signal to the quantity of encoding bits of the transmission channel. When the quantity of heterogeneous sound sources is less than or equal to the quantity of channels of the virtual speaker signal, the initial ratio of the quantity of encoding bits of the virtual speaker signal to the quantity of encoding bits of the transmission channel is increased based on a preset adjustment value, and an increased ratio is used as a ratio of the quantity of encoding bits of the virtual speaker signal to the quantity of encoding bits of the transmission channel. For example, the increased ratio is equal to a sum of the preset adjustment value and the initial ratio.

In some embodiments of this application, a ratio of the quantity of encoding bits of the residual signal to the quantity of encoding bits of the transmission channel=1.0−the ratio of the quantity of encoding bits of the virtual speaker signal to the quantity of encoding bits of the transmission channel.

In some embodiments of this application, in addition to performing the foregoing operations, the method performed by the encoder side may further include:
encoding the current frame and the sound field classification result, and writing the encoded current frame and sound field classification result into a bitstream.

The sound field classification result may be encoded into the bitstream. After the encoder side sends the bitstream to a decoder side, the decoder side may obtain the sound field classification result based on the bitstream. The decoder side may obtain, by parsing the bitstream, the sound field classification result carried in the bitstream, and obtain a sound field distribution status of the current frame based on the sound field classification result, so that the current frame may be decoded, to obtain the three-dimensional audio signal.

In some embodiments of this application, the encoding the current frame and the sound field classification result may specifically include: directly encoding the current frame, or first processing the current frame; and after obtaining the virtual speaker signal and the residual signal, encoding the virtual speaker signal and the residual signal. For example, the encoder side may specifically be a core encoder. The core encoder encodes the virtual speaker signal, the residual signal, and the sound field classification result, to obtain the bitstream. The bitstream may also be referred to as an audio signal encoding bitstream.

The three-dimensional audio signal processing method provided in this embodiment of this application may include an audio encoding method and an audio decoding method. The audio encoding method is performed by an audio encoding apparatus, the audio decoding method is performed by an audio decoding apparatus, and the audio encoding apparatus may communicate with the audio decoding apparatus. FIG. 4 to FIG. 6 are performed by the audio encoding apparatus. The following describes a three-dimensional audio signal processing method performed by the audio decoding apparatus (which is referred to as a decoder side) according to an embodiment of this application. As shown in FIG. 7, the method mainly includes the following operations.

701: Receive a bitstream.

A decoder side receives the bitstream from an encoder side. The bitstream carries a sound field classification result.

702: Decode the bitstream, to obtain the sound field classification result of a current frame.

The decoder side parses the bitstream, and obtains the sound field classification result of the current frame from the bitstream. The sound field classification result is obtained by the encoder side according to the embodiments shown in FIG. 4 to FIG. 6.

703: Obtain a three-dimensional audio signal of the decoded current frame based on the sound field classification result.

After obtaining the sound field classification result, the decoder side parses the bitstream based on the sound field classification result, to obtain the three-dimensional audio signal of the decoded current frame. A decoding process of the current frame is not limited in this embodiment of this application. In this embodiment of this application, the decoder side may decode the current frame based on the sound field classification result. The sound field classification result can be used to decode the current frame in the bitstream. Therefore, the decoder side performs decoding in a decoding manner matching a sound field of the current frame, to obtain the three-dimensional audio signal sent by the encoder side. This implements transmission of the audio signal from the encoder side to the decoder side.

For example, the decoder side can determine, based on the sound field classification result transmitted in the bitstream, a decoding mode and/or a decoding parameter consistent with an encoding mode and/or an encoding parameter of the encoder side. In comparison with a manner in which the encoder side transmits the encoding mode and/or the encoding parameter to the decoder side, a quantity of encoding bits is reduced.

In some embodiments of this application, the obtaining a three-dimensional audio signal of the decoded current frame based on the sound field classification result in operation 703 includes:
G1: determining a decoding mode of the current frame based on the sound field classification result; and
G2: obtaining the three-dimensional audio signal of the decoded current frame based on the decoding mode.

The decoding mode corresponds to the encoding mode in the foregoing embodiments. An implementation of operation G1 is similar to operation 504 in the foregoing embodiment. Details are not described herein again. After obtaining the decoding mode, the decoder side may decode the bitstream based on the decoding mode, to obtain the three-dimensional audio signal of the decoded current frame.

Further, in some embodiments of this application, the determining a decoding mode of the current frame based on the sound field classification result in operation G1 includes:
when the sound field classification result includes a quantity of heterogeneous sound sources, or the sound field classification result includes a quantity of heterogeneous sound sources and a sound field type, determining the decoding mode of the current frame based on the quantity of heterogeneous sound sources;
when the sound field classification result includes a sound field type, or the sound field classification result includes a quantity of heterogeneous sound sources and a sound field type, determining the decoding mode of the current frame based on the sound field type; or
when the sound field classification result includes a quantity of heterogeneous sound sources and a sound field type, determining the decoding mode of the current frame based on the quantity of heterogeneous sound sources and the sound field type.

Implementations of the foregoing operations are similar to implementations of operation E1 to operation E3 in the foregoing embodiment. Details are not described herein again.

In some embodiments of this application, the determining the decoding mode of the current frame based on the quantity of heterogeneous sound sources includes:
when the quantity of heterogeneous sound sources meets a preset condition, determining that the decoding mode is a first decoding mode; or
when the quantity of heterogeneous sound sources does not meet a preset condition, determining that the decoding mode is a second decoding mode.

The first decoding mode is an HOA decoding mode based on virtual speaker selection or an HOA decoding mode based on directional audio coding, the second decoding mode is an HOA decoding mode based on virtual speaker selection or an HOA decoding mode based on directional audio coding, and the first decoding mode and the second decoding mode are different decoding modes.

It should be noted that the preset condition is a condition set by the decoder side to identify different decoding modes, and an implementation of the preset condition is not limited.

In some embodiments of this application, the preset condition includes that the quantity of heterogeneous sound sources is greater than a first threshold or less than a second threshold, and the second threshold is greater than the first threshold; or
the preset condition includes that the quantity of heterogeneous sound sources is not greater than a first threshold or not less than a second threshold, and the second threshold is greater than the first threshold.

In some embodiments of this application, the obtaining a three-dimensional audio signal of the decoded current frame based on the sound field classification result in operation 703 includes:
H1: determining a decoding parameter of the current frame based on the sound field classification result; and
H2: obtaining the three-dimensional audio signal of the decoded current frame based on the decoding parameter.

The decoding parameter corresponds to the encoding parameter in the foregoing embodiments. An implementation of operation H1 is similar to operation 604 in the foregoing embodiment. Details are not described herein again. After obtaining the decoding parameter, the decoder side may decode the bitstream based on the decoding parameter, to obtain the three-dimensional audio signal of the decoded current frame.

In some embodiments of this application, the decoding parameter includes at least one of the following: a quantity of channels of a virtual speaker signal, a quantity of channels of a residual signal, a quantity of decoding bits of a virtual speaker signal, or a quantity of decoding bits of a residual signal.

The virtual speaker signal and the residual signal are obtained by decoding the bitstream.

In some embodiments of this application, the sound field classification result includes the quantity of heterogeneous sound sources and the sound field type.

When the sound field type is a heterogeneous sound field, the quantity of channels of the virtual speaker signal meets the following relationship:

F=min(S, PF), where
F is the quantity of channels of the virtual speaker signal, S is the quantity of heterogeneous sound sources, and PF is a quantity of channels of the virtual speaker signal preset by a decoder; or
when the sound field type is a dispersive sound field, the quantity of channels of the virtual speaker signal meets the following relationship:

F=1, where
F is the quantity of channels of the virtual speaker signal.

In some embodiments of this application, when the sound field type is a dispersive sound field, the quantity of channels of the residual signal meets the following relationship:

R=max(C−1, PR), where
PR is a quantity of channels of the residual signal preset by the decoder, and C is a sum of the quantity of channels of the residual signal preset by the decoder and the quantity of channels of the virtual speaker signal preset by the decoder; or
when the sound field type is a heterogeneous sound field, the quantity of channels of residual signal meets the following relationship:

R=C−F, where
R is the quantity of channels of the residual signal, C is a sum of a quantity of channels of the residual signal preset by the decoder and the quantity of channels of the virtual speaker signal preset by the decoder, and F is the quantity of channels of the virtual speaker signal.

It should be noted that the quantity of channels of the virtual speaker signal preset by the decoder is equal to the quantity of channels of the virtual speaker signal preset by the encoder. Similarly, the quantity of channels of the residual signal preset by the decoder is equal to the quantity of channels of the residual signal preset by the encoder.

In some embodiments of this application, the sound field classification result includes the quantity of heterogeneous sound sources.

The quantity of channels of the virtual speaker signal meets the following relationship:

F=min(S, PF), where
F is the quantity of channels of the virtual speaker signal, S is the quantity of heterogeneous sound sources, and PF is a quantity of channels of the virtual speaker signal preset by a decoder.

In some embodiments of this application, the quantity of channels of the residual signal meets the following relationship:

R=C−F, where
R is the quantity of channels of the residual signal, C is a sum of a quantity of channels of the residual signal preset by the decoder and the quantity of channels of the virtual speaker signal preset by the decoder, and F is the quantity of channels of the virtual speaker signal.

It should be noted that an implementation of the decoding parameter is similar to the implementation of the encoding parameter in the foregoing embodiment. Details are not described herein again.

In some embodiments of this application, the sound field classification result includes the quantity of heterogeneous sound sources, or the sound field classification result includes the quantity of heterogeneous sound sources and the sound field type.

The quantity of decoding bits of the virtual speaker signal is obtained based on a ratio of the quantity of decoding bits of the virtual speaker signal to a quantity of decoding bits of a transmission channel.

The quantity of decoding bits of the residual signal is obtained based on a ratio of the quantity of decoding bits of the virtual speaker signal to the quantity of decoding bits of the transmission channel.

The quantity of decoding bits of the transmission channel includes the quantity of decoding bits of the virtual speaker signal and the quantity of decoding bits of the residual signal, and when the quantity of heterogeneous sound sources is less than or equal to the quantity of channels of the virtual speaker signal, the ratio of the quantity of decoding bits of the virtual speaker signal to the quantity of decoding bits of the transmission channel is obtained by increasing an initial ratio of the quantity of decoding bits of the virtual speaker signal to the quantity of decoding bits of the transmission channel.

For better understanding and implementation of the foregoing solutions in embodiments of this application, specific descriptions are provided below by using corresponding application scenarios as examples.

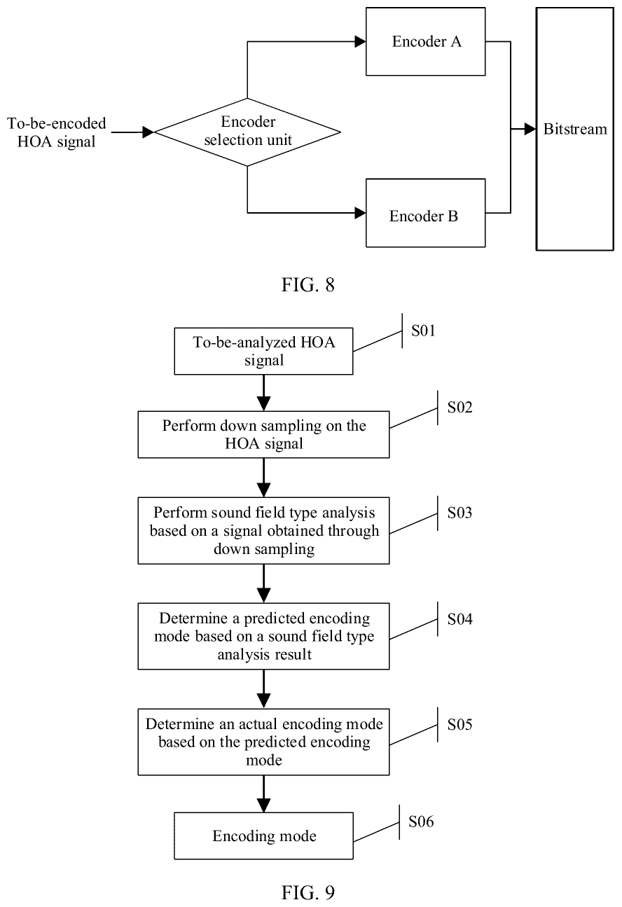

In this embodiment of this application, an example in which the three-dimensional audio signal is an HOA signal is used. A sound field classification method for an HOA signal in this embodiment of this application is applied to a hybrid HOA encoder. FIG. 8 shows a basic encoding procedure. The encoder side performs classification on a to-be-encoded HOA signal, to determine whether the to-be-encoded HOA signal of the current frame is suitable for an HOA encoding scheme based on virtual speaker selection or an HOA encoding scheme based on directional audio coding DirAC, and determine an HOA encoding mode of the current frame based on a sound field classification result. Specifically, the HOA encoder includes an encoder selection unit. The encoder selection unit performs sound field classification on the to-be-encoded HOA signal, and determines an encoding mode of the current frame; and selects, based on the encoding mode, an encoder A or an encoder B for encoding, to obtain a final encoded bitstream. The encoder A and the encoder B indicate different types of encoders, and each type of encoder is adapted to a sound field type of the current frame. When an encoder adapted to the sound field type is used for encoding, a compression ratio of a signal can be improved.

A specific process of performing sound field classification on the to-be-encoded HOA signal and determining an encoding mode includes:
performing sound field classification on the to-be-encoded HOA signal, to obtain a sound field classification result; and
determining, based on the sound field classification result, the encoding mode corresponding to the current frame.

The encoding mode of the current frame indicates a selection manner of the encoder of the current frame. A criterion for determining an encoder selection identifier may be determined based on a sound field type of an HOA signal to which the encoder A and the encoder B are applicable. For example, a signal type processed by the encoder A is an HOA signal with a heterogeneous sound field and whose quantity of heterogeneous sound sources is less than 3, and a signal type processed by the encoder B is an HOA signal with a heterogeneous sound field and whose quantity of heterogeneous sound sources is greater than or equal to 3. Alternatively, a signal type processed by the encoder B is an HOA signal with a dispersive sound field or whose quantity of heterogeneous sound sources is greater than or equal to 3.

It should be noted that hangover (hangover) window processing may also be performed on the sound field classification result, to ensure that encoding modes between consecutive frames are not frequently switched. There are a plurality of hangover window processing methods. This is not limited in this embodiment of this application. For example, a processing manner may be storing an encoder selection identifier whose length is N frames in the hangover window, where the N frames include encoder selection identifiers of the current frame and N−1 frames before the current frame; and when encoder selection identifiers are accumulated to a specified threshold, updating an encoding type indication identifier of the current frame. In one embodiment, in addition to hangover window processing, other processing may be used to perform correction on the sound field classification result.

As shown in FIG. 9, a procedure of determining an encoding mode of an HOA signal mainly includes:

S01: Obtain a to-be-analyzed HOA signal.

S02: Perform downsampling on the HOA signal.

That performing downsampling on the to-be-analyzed HOA signal is an optional operation is not limited.

Down sampling is performed on the to-be-analyzed HOA signal, to reduce calculation complexity. The to-be-analyzed HOA signal may be a time domain HOA signal, or may be a frequency domain HOA signal. The to-be-analyzed HOA signal may include all channels or some HOA channels (for example, an FOA channel). For example, the to-be-analyzed HOA signal may be all sampling points or 1/Q down-sampling points. For example, in this embodiment, 1/120 down-sampling points are used.

For example, an order of the HOA signal of the current frame is 3, a quantity of channels of the HOA signal is 16, and a frame length of the current frame is 20 milliseconds (ms), that is, the signal of the current frame includes 960 sampling points. After a to-be-encoded HOA signal of the current frame is processed by 1/120 downsampling, each channel of the signal includes eight sampling points. In other words, the HOA signal has 16 channels, and each channel has eight sampling points, forming an input signal of sound field type analysis, namely, the to-be-analyzed HOA signal.

S03: Perform sound field type analysis based on a signal obtained through downsampling.

After downsampling is performed on the HOA signal, the sound field type is obtained by analyzing a quantity of heterogeneous sound sources of the HOA signal.

For example, sound field type analysis in this embodiment of this application may be performing linear decomposition on the HOA signal, obtaining a linear decomposition result through linear decomposition, and then obtaining a sound field classification result based on the linear decomposition result.

For example, the quantity of heterogeneous sound sources can be obtained based on the linear decomposition result. For example, the linear decomposition result may include a feature value. That the quantity of heterogeneous sound sources is estimated based on a ratio between feature values specifically includes:
performing singular value decomposition on the to-be-analyzed HOA signal, to obtain a singular value v[i], where i=0, 1, , . . . , min(L, K)−1.

L is equal to the quantity of channels of the HOA signal, and K is a quantity of signal points of each channel of the current frame. For example, the quantity of signal points may be a quantity of frequencies. In this embodiment, L=16, K=8, and min(L, K)=8.

A ratio temp[i] between singular values v is calculated, and used as a sound field classification parameter, where for i=0, 1, . . . , min(L, K)−2:

temp[i]=v[i]/v[i+1].

A heterogeneous sound source determining threshold is 100, and the quantity n of heterogeneous sound sources may be estimated in the following manner:
determining whether temp[i] is greater than 100 from i=0; and if temp[i] is greater than or equal to 100, and temp[i]≥100 is met, stopping determining; otherwise i=i+1, continuing to perform determining. When determining is stopped, the quantity n of heterogeneous sound sources is equal to the sequence number i when determining is stopped plus 1. For example, when i=0, if temp[0]≥100, determining is stopped, and the quantity n of heterogeneous sound sources is equal to 1. Otherwise, i is set to 1, and determining continues to be performed when i=1. When i=1, and temp[1]≥100, determining is stopped, and the quantity n of heterogeneous sound sources is equal to i+1=2.

S04: Determine a predicted encoding mode based on a sound field type analysis result.

The predicted encoding mode is determined based on the quantity n of heterogeneous sound sources.

When 0<n<3, the predicted encoding mode is an encoding mode 1.

When n≥3 or n=0, the predicted encoding mode is an encoding mode 2.

For example, the encoding mode 1 may be an HOA encoding mode based on virtual speaker selection. The encoding mode 2 may be an HOA encoding scheme based on directional audio coding DirAC.

S05: Determine an actual encoding mode based on the predicted encoding mode.

After the predicted encoding mode of the current frame is determined, the actual encoding mode is then determined. For example, a hangover window is used to determine the actual encoding mode. In the hangover window, when expected encoding modes 2 of a plurality of frames in the hangover window are accumulated to a specified threshold, the actual encoding mode of the current frame is the encoding mode 2. Otherwise, the actual encoding mode of the current frame is the encoding mode 1.

For example, there are expected encoding mode results of 10 frames in the hangover window, including an encoding mode decision result of the current frame in operation S03 and encoding mode results of nine frames before the current frame. If frames, in the expected encoding mode results of the 10 frames, whose encoding modes are the encoding mode 2 are accumulated to seven frames, the actual encoding mode of the current frame is determined as the encoding mode 2.

S06: Obtain a final encoding mode.

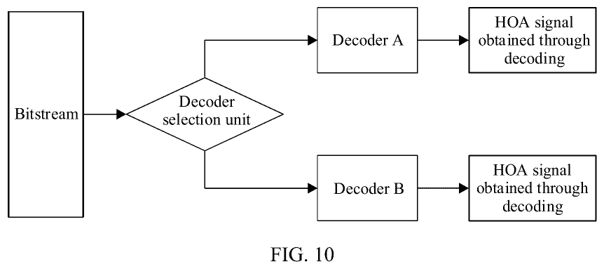

A basic decoding procedure of a hybrid HOA decoder corresponding to an encoder side is shown in FIG. 10. A decoder side obtains a bitstream from the encoder side, and then parses the bitstream, to obtain an HOA decoding mode of the current frame. A corresponding decoding scheme is selected, based on the HOA decoding mode of the current frame, for decoding, to obtain a reconstructed HOA signal. Specifically, the decoder side includes a decoder selection unit. The decoder selection unit parses the bitstream, determines the decoding mode, and selects, based on the decoding mode, a decoder A or a decoder B for decoding, to obtain the reconstructed HOA signal. The decoder A and the decoder B indicate different types of decoder, and each type of decoder is adapted to a sound field type of the current frame. When a decoder adapted to the sound field type is used for decoding, an HOA signal can be correctly reconstructed.

It can be learned from the foregoing descriptions that sound field classification is performed on a to-be-encoded HOA signal, and an encoding mode is determined based on a sound field classification result, so that different encoding modes are used for appropriate signal types, to obtain maximum compression efficiency for signals of different types.

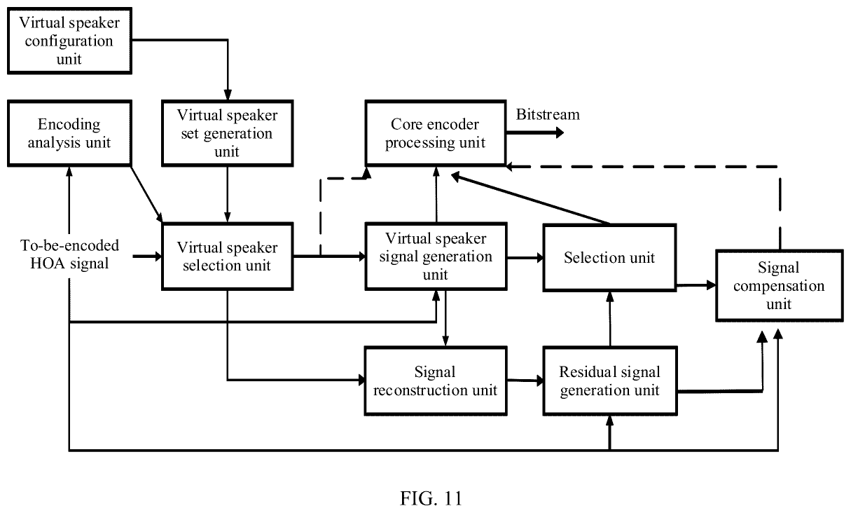

The following describes an HOA encoder based on virtual speaker selection according to an embodiment of this application. FIG. 11 shows a basic encoding procedure.

An encoder side may include: a virtual speaker configuration unit, an encoding analysis unit, a virtual speaker set generation unit, a virtual speaker selection unit, a virtual speaker signal generation unit, a core encoder processing unit, a signal reconstruction unit, a residual signal generation unit, a selection unit, and a signal compensation unit. The following separately describes functions of the units included in the encoder side. In this embodiment of this application, the encoder side shown in FIG. 11 may generate one virtual speaker signal or a plurality of virtual speaker signals. A procedure of generating the plurality of virtual speaker signals may be performing generation based on a structure of the encoder for a plurality of times shown in FIG. 11. The following uses a procedure of generating one virtual speaker signal as an example.

The virtual speaker configuration unit is configured to configure a virtual speaker in a virtual speaker set, to obtain a plurality of virtual speakers.

The virtual speaker configuration unit outputs a virtual speaker configuration parameter based on encoder configuration information. The encoder configuration information includes but is not limited to an HOA order, an encoding bit rate, user-defined information, and the like. The virtual speaker configuration parameter includes but is not limited to a quantity of virtual speakers, an HOA order of a virtual speaker, position coordinates of a virtual speaker, and the like.

The virtual speaker configuration parameter output by the virtual speaker configuration unit is used as an input of the virtual speaker set generation unit.

The encoding analysis unit is configured to perform encoding analysis on a to-be-encoded HOA signal, for example, analyze sound field distribution, including features such as a quantity of sound sources, directivity, and a dispersive degree of the to-be-encoded HOA signal, of the to-be-encoded HOA signal. The feature is used as one of determining conditions for determining how to select a target virtual speaker.

In this embodiment of this application, that the encoder side may alternatively not include the encoding analysis unit is not limited. In other words, the encoder side may not analyze an input signal, but use a default configuration to determine how to select the target virtual speaker.

The encoder side obtains the to-be-encoded HOA signal. For example, the encoder side may use an HOA signal recorded from an actual acquisition device or an HOA signal synthesized by using an artificial audio object as an input of the encoder. In addition, the to-be-encoded HOA signal input by the encoder may be a time domain HOA signal or a frequency domain HOA signal.

The virtual speaker set generation unit is configured to generate the virtual speaker set. The virtual speaker set may include a plurality of virtual speakers, and the virtual speaker in the virtual speaker set may also be referred to as a “candidate virtual speaker”.

The virtual speaker set generation unit generates an HOA coefficient of a specified candidate virtual speaker based on the virtual speaker configuration parameter. Coordinates (namely, position coordinates or position information) of the candidate virtual speaker and an HOA order of the candidate virtual speaker are required to generate the HOA coefficient of the candidate virtual speaker. A method for determining the coordinates of the candidate virtual speaker includes but is not limited to generating K virtual speakers according to an equidistance principle, and generating, according to a principle of auditory perception, K candidate virtual speakers that are non-evenly distributed. The following describes an example of generating a fixed quantity of virtual speakers that are evenly distributed.

Coordinates of candidate virtual speakers that are evenly distributed are generated based on a quantity of candidate virtual speakers, for example, approximately even speaker arrangement is obtained by using a numerical iterative calculation method.

The HOA coefficient, output by the virtual speaker set generation unit, of the candidate virtual speaker is used as an input of the virtual speaker selection unit.

The virtual speaker selection unit is configured to select the target virtual speaker from the plurality of candidate virtual speakers in the virtual speaker set based on the to-be-encoded HOA signal, where the target virtual speaker may be referred to as a “virtual speaker matching the to-be-encoded HOA signal” or a matching virtual speaker.

The virtual speaker selection unit matches the to-be-encoded HOA signal with the HOA coefficient, output by the virtual speaker set generation unit, of the candidate virtual speaker, and selects a specified matching virtual speaker.

In this embodiment of this application, sound field classification is performed on the to-be-encoded HOA signal, to obtain a sound field classification result, and an encoding parameter is determined based on the sound field classification result.

The encoding analysis unit is configured to perform encoding analysis based on the to-be-encoded HOA signal, where the analysis may include: performing sound field classification based on the to-be-encoded HOA signal. For a sound field classification method, refer to the foregoing embodiment. Details are not described herein again.

The encoding parameter is determined based on the sound field classification result. The encoding parameter may include at least one of a quantity of channels of a virtual speaker signal, a quantity of channels of a residual signal, or a quantity of voting rounds for searching for a best matching speaker in an HOA encoding scheme based on virtual speaker selection.

Specifically, the virtual speaker selection unit matches, based on the determined quantity of voting rounds for searching for the best matching speaker and the channels of the virtual speaker signal, a to-be-encoded HOA coefficient with the HOA coefficient, output by the virtual speaker set generation unit, of the candidate virtual speaker, selects a best matching virtual speaker, and obtains an HOA coefficient of the matching virtual speaker. A quantity of best matching virtual speakers is equal to the quantity of channels of the virtual speaker signal.

The virtual speaker selection unit matches, by using a best matching speaker searching method based on voting, the to-be-encoded HOA coefficient with the HOA coefficient, output by the virtual speaker set generation unit, of the candidate virtual speaker, selects the best matching virtual speaker, and may determine, based on the sound field classification result, the quantity I of voting rounds for searching for the best matching speaker.

The quantity I of voting rounds needs to comply with the following rules: a minimum quantity of voting rounds is one, a maximum quantity does not exceed a total quantity of speakers (for example, 1024 speakers obtained by the virtual speaker set generation unit) and the quantity of channels of the virtual speaker signal (a quantity of virtual speaker signals transmitted by the encoder, namely, N transmission channels correspondingly generated by N best matching speakers). Usually, the quantity of channels of the virtual speaker signal is less than the total quantity of speakers.

A method for estimating the quantity of voting rounds is as follows:
determining, based on the quantity of heterogeneous sound sources, obtained in the sound field classification result, in a sound field, the quantity I of voting rounds for selecting the speaker.

The quantity I of voting rounds meets 1≤I≤d. d is a quantity of sound sources in different directions included in the sound field, namely, a quantity of estimated heterogeneous sound sources in the sound field classification result. For example, I=d.

The quantity of channels of the virtual speaker signal and the quantity of channels of the residual signal are determined based on the sound field type.

Then, an embodiment of this application provides a method for selecting a quantity F of channels of an adaptive virtual speaker signal.

When the sound field type is a heterogeneous sound field, F=min(S, PF), where S is a quantity of heterogeneous sound sources in the sound field, and PF is a quantity of channels of the virtual speaker signal preset by the encoder.

When the sound field type is a dispersive sound field, F=1.

Then, an embodiment of this application provides a method for selecting a quantity R of channels of an adaptive residual signal.

When the sound field type is a dispersive sound source field, R=max(C−1, PR), where C is a preset total quantity of transmission channels, and PR is a quantity of residual signals preset by the encoder. For example, C is a sum of PF and PR.

When the sound field type is a heterogeneous sound field, R=C−F.

A method for determining bit allocation of the virtual speaker signal and the residual signal based on the sound field classification result is as follows:

When the quantity of heterogeneous sound sources is less than or equal to the quantity of channels of the virtual speaker signal, energy of the residual signal is low, and therefore more bits may be allocated to the channel of the virtual speaker signal.

In some embodiments, the virtual speaker signal and the residual signal are divided into two groups, namely, a virtual speaker signal group and a residual signal group. When the quantity of heterogeneous sound sources is less than or equal to the quantity of channels of the virtual speaker signal, a preset allocation proportion of the virtual speaker signal group is increased based on a preset adjustment value, and an increased allocation proportion of the virtual speaker signal group is used as an allocation proportion of the virtual speaker signal group.

An allocation proportion of the residual signal group=1.0−the allocation proportion of the virtual speaker signal group.

The virtual speaker signal generation unit calculates a virtual speaker signal based on the to-be-encoded HOA coefficient and an HOA coefficient of the matching virtual speaker.

The signal reconstruction unit reconstructs the HOA signal based on the virtual speaker signal and the HOA coefficient of the matching virtual speaker.

The residual signal generation unit calculates a residual signal based on the quantity of channels of the residual signal determined in operation 1, the to-be-encoded HOA coefficient, and the reconstructed HOA signal output by the HOA signal reconstruction unit.

The signal compensation unit needs to perform information compensation on a residual signal that is not transmitted because an information loss occurs when a quantity of channels that is less than an N^{th}-order ambisonic coefficient is selected as to-be-transmitted residual signals, in comparison with a residual signal with the N^{th}-order ambisonic coefficient.

The virtual speaker signal has high amplitude or energy, and the to-be-transmitted residual signal has low amplitude or energy. Therefore, the selection unit pre-allocates all available bits to the virtual speaker signal and the to-be-transmitted residual signal. Obtained bit pre-allocation information is used to guide the core encoder for processing.

The core encoder processing unit performs core encoder processing on the transmission channel and outputs a transmission bitstream. The transmission channel includes the channel of the virtual speaker signal and the channel of the residual signal.

The encoding parameter is determined based on the sound field classification result. The encoding parameter may further include at least one of bit allocation of the virtual speaker signal and bit allocation of the residual signal in the HOA encoding scheme based on virtual speaker selection. If the bit allocation of the virtual speaker signal and the bit allocation of the residual signal are determined based on the sound field classification result, bit allocation of the virtual speaker signal and the residual signal needs to be determined based on the sound field classification result.

In some embodiments, the method for determining bit allocation of the virtual speaker signal and the residual signal based on sound field classification result is as follows: It is assumed that the quantity of channels of the virtual speaker signal is F, the quantity of channels of the residual signal is R, and a total quantity of bits that can be used to encode the virtual speaker signal and the residual signal is numbit.

In one manner, a total quantity of encoding bits of the virtual speaker signal a total quantity of encoding bits of the residual signal are first determined, and then a quantity of encoding bits of each channel is determined. For example, the total quantity of encoding bits of the virtual speaker signal is:

$${core}_{numbit} = round ( fac 1 * \frac{numbit}{fac 1 * F + fac 2 * R} )$$

fac1 is a weighting factor allocated to the encoding bit of the virtual speaker signal, fac2 is a weighting factor allocated to the encoding bit of the residual signal, and round ( ) indicates rounding down. For example, fac1>fac2. For example, fac1=2, and fac2=1.

The total quantity of encoding bits of the residual signal is res_numbit=numbit−core_numbit.

Then, encoding bits of each channel of the virtual speaker signal are allocated according to a bit allocation criterion of the virtual speaker signal, and encoding bits of each channel of the residual signal are allocated according to a bit allocation criterion of the residual signal.

Alternatively, the total quantity of encoding bits of the residual signal is:

$$res\_numbit = round ( fac 2 * R * \frac{numbit}{fac 1 * F + fac 2 * R} )$$

fac1 is a weighting factor allocated to the encoding bit of the virtual speaker signal, fac2 is a weighting factor allocated to the encoding bit of the residual signal, and round( ) indicates rounding down. For example, fac1>fac2. For example, fac1=2, and fac2=1.

The total quantity of encoding bits of the virtual speaker signal is core_numbit=numbit−res_numbit.

Then, encoding bits of each channel of the virtual speaker signal are allocated according to a bit allocation criterion of the virtual speaker signal, and encoding bits of each channel of the residual signal are allocated according to a bit allocation criterion of the residual signal.

In addition, the quantity of encoding bits of each channel may alternatively be directly determined. For example, a quantity of encoding bits of each virtual speaker signal is:

$$core\_ch \_numbit = round ( fac 1 * \frac{numbit}{fac 1 * F + fac 2 * R} )$$

A quantity of encoding bits of each residual signal is:

$$res\_ch \_numbit = round ( fac 2 * \frac{numbit}{fac 1 * F + fac 2 * R} )$$

It should be noted that a bit allocation result that is finally used to encode the virtual speaker signal and the residual signal may be determined based on an adjusted bit allocation result obtained by using the foregoing method. After obtaining the bit allocation result for encoding the virtual speaker signal and the residual signal, the core encoder processing unit encodes the virtual speaker signal and the residual signal based on the bit allocation result.

Sound field classification is performed on the to-be-encoded HOA signal, the encoding parameter is determined based on the sound field classification result, and the to-be-encoded signal is encoded based on the determined encoding parameter. The encoding parameter includes at least one of the quantity of channels of the virtual speaker signal, the quantity of channels of the residual signal, the bit allocation of the virtual speaker signal, bit allocation of the residual signal, or the quantity of voting rounds for searching for the best matching speaker in the HOA encoding scheme based on virtual speaker selection. For descriptions of the encoding parameter, refer to the foregoing content. Details are not described herein again.

It can be learned from the foregoing example that, in this embodiment of this application, sound field classification is performed on the to-be-encoded HOA signal, so that an appropriate encoding mode and/or encoding parameter are/is selected based on different features of the to-be-encoded HOA signal, to encode the HOA signal. This improves compression efficiency and auditory quality.

A decoding procedure performed by a decoder side is not described in detail in embodiments of this application.

It should be noted that, for brief description, the foregoing method embodiments are represented as a series of actions. However, a person skilled in the art should appreciate that this application is not limited to the described order of the actions, because according to this application, some operations may be performed in other orders or simultaneously. It should further be appreciated by a person skilled in the art that embodiments described in this specification all belong to example embodiments, and the involved actions and modules are not necessarily required by this application.

To better implement the solutions of embodiments of this application, a related apparatus for implementing the solutions is further provided below.

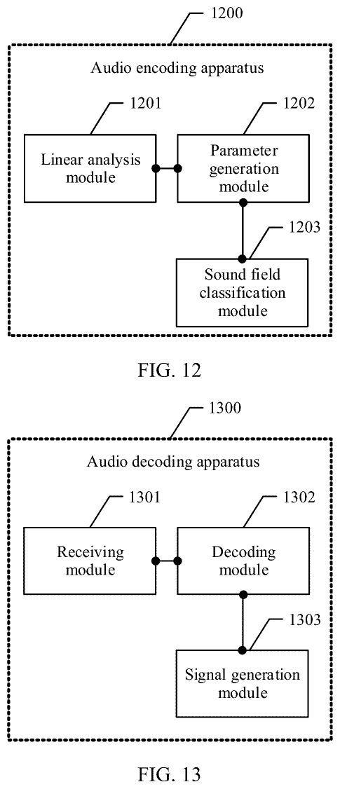

FIG. 12 shows a three-dimensional audio signal processing apparatus according to an embodiment of this application. For example, the three-dimensional audio signal processing apparatus is specifically an audio encoding apparatus 1200, and may include a linear analysis module 1201, a parameter generation module 1202, and a sound field classification module 1203.

The linear analysis module is configured to perform linear decomposition on a three-dimensional audio signal, to obtain a linear decomposition result.

The parameter generation module is configured to obtain, based on the linear decomposition result, a sound field classification parameter corresponding to a current frame.

The sound field classification module is configured to determine a sound field classification result of the current frame based on the sound field classification parameter.

In some embodiments of this application, the three-dimensional audio signal includes a higher-order ambisonics HOA signal or a first-order ambisonics FOA signal.

In some embodiments of this application, the linear analysis module is configured to: perform singular value decomposition on the current frame, to obtain a singular value corresponding to the current frame, where the linear decomposition result includes the singular value; perform principal component analysis on the current frame, to obtain a first feature value corresponding to the current frame, where the linear decomposition result includes the first feature value; or perform independent component analysis on the current frame, to obtain a second feature value corresponding to the current frame, where the linear decomposition result includes the second feature value.

In some embodiments of this application, there are a plurality of linear decomposition results, and there are a plurality of sound field classification parameters.

The parameter generation module is configured to: obtain a ratio of an i^{th} linear analysis result of the current frame to an (i+1)^{th} linear analysis result of the current frame, where i is a positive integer; and obtain, based on the ratio, an i^{th} sound field classification parameter corresponding to the current frame.

In one embodiment, the i^{th} linear analysis result and the (i+1)^{th} linear analysis result are two consecutive linear analysis results of the current frame.

In some embodiments of this application, there are a plurality of sound field classification parameters, and the sound field classification result includes a sound field type. The sound field classification module is configured to: when values of the plurality of sound field classification parameters all meet a preset dispersive sound source decision condition, determine that the sound field type is a dispersive sound field; or when at least one of values of the plurality of sound field classification parameters meets a preset heterogeneous sound source decision condition, determine that the sound field type is a heterogeneous sound field.

In some embodiments of this application, the dispersive sound source decision condition includes that the value of the sound field classification parameter is less than a preset heterogeneous sound source determining threshold; or the heterogeneous sound source decision condition includes that the value of the sound field classification parameter is greater than or equal to a preset heterogeneous sound source determining threshold.

In some embodiments of this application, there are a plurality of sound field classification parameters.

The sound field classification result includes a sound field type, or the sound field classification result includes a quantity of heterogeneous sound sources and a sound field type.

The sound field classification module is configured to: obtain, based on values of the plurality of sound field classification parameters, the quantity of heterogeneous sound sources corresponding to the current frame; and determine the sound field type based on the quantity of heterogeneous sound sources corresponding to the current frame.

In some embodiments of this application, there are a plurality of sound field classification parameters.

The sound field classification result includes a quantity of heterogeneous sound sources.

The sound field classification module is configured to obtain, based on values of the plurality of sound field classification parameters, a quantity of heterogeneous sound sources corresponding to the current frame.

In some embodiments of this application, the plurality of sound field classification parameters are temp[i], i=0, 1, . . . , min(L, K)−2, L indicates a quantity of channels of the current frame, K is a quantity of signal points corresponding to each channel of the current frame, and min indicates an operation in which a minimum value is selected.

The sound field classification module is configured to sequentially perform the following determining process from i=0:
determining whether temp[i] is greater than a preset heterogeneous sound source determining threshold; and
when temp[i] is less than the heterogeneous sound source determining threshold in this determining procedure, updating a value of i to i+1, and continuing to perform a next determining procedure; or
when temp[i] is greater than or equal to the heterogeneous sound source determining threshold in this determining procedure, terminating execution of the determining procedure, and determining that i in this determining procedure plus 1 is equal to the quantity of heterogeneous sound sources.

In some embodiments of this application, the sound classification module is further configured to:
when the quantity of heterogeneous sound sources meets a first preset condition, determine that the sound field type is a first sound field type; or
when the quantity of heterogeneous sound sources does not meet a first preset condition, determine that the sound field type is a second sound field type.

A quantity of heterogeneous sound sources corresponding to the first sound field type is different from a quantity of heterogeneous sound sources corresponding to the second sound field type.

In some embodiments of this application, the first preset condition includes that the quantity of heterogeneous sound sources is greater than a first threshold or less than a second threshold, and the second threshold is greater than the first threshold; or
the first preset condition includes that the quantity of heterogeneous sound sources is not greater than a first threshold or not less than a second threshold, and the second threshold is greater than the first threshold.

In some embodiments of this application, the audio encoding apparatus further includes an encoding mode determining module (not shown in FIG. 12). The encoding mode determining module is configured to determine, based on the sound field classification result, an encoding mode corresponding to the current frame.

In one embodiment, the encoding mode determining module is configured to: when the sound field classification result includes the quantity of heterogeneous sound sources, or the sound field classification result includes the quantity of heterogeneous sound sources and the sound field type, determine, based on the quantity of heterogeneous sound sources, the encoding mode corresponding to the current frame; when the sound field classification result includes the sound field type, or the sound field classification result includes the quantity of heterogeneous sound sources and the sound field type, determine, based on the sound field type, the encoding mode corresponding to the current frame; or when the sound field classification result includes the quantity of heterogeneous sound sources and the sound field type, determine, based on the quantity of heterogeneous sound sources and the sound field type, the encoding mode corresponding to the current frame.

In some embodiments of this application, the encoding mode determining module is configured to: when the quantity of heterogeneous sound sources meets a second preset condition, determine that the encoding mode is the first encoding mode; or when the quantity of heterogeneous sound sources does not meet a second preset condition, determine that the encoding mode is the second encoding mode.

The first encoding mode is an HOA encoding mode based on virtual speaker selection or an HOA encoding mode based on directional audio coding, the second encoding mode is an HOA encoding mode based on virtual speaker selection or an HOA encoding mode based on directional audio coding, and the first encoding mode and the second encoding mode are different encoding modes.

In some embodiments of this application, the second preset condition includes that the quantity of heterogeneous sound sources is greater than the first threshold or less than the second threshold, and the second threshold is greater than the first threshold; or
the second preset condition includes that the quantity of heterogeneous sound sources is not greater than the first threshold or not less than the second threshold, and the second threshold is greater than the first threshold.

In some embodiments of this application, the encoding mode determining module is configured to: when the sound field type is a heterogeneous sound field, determine that the encoding mode is the HOA encoding mode based on virtual speaker selection; or when the sound field type is a dispersive sound field, determine that the encoding mode is the HOA encoding mode based on directional audio coding.

In some embodiments of this application, the encoding mode determining module is configured to: determine, based on the sound field classification result of the current frame, an initial encoding mode corresponding to the current frame; obtain a hangover window in which the current frame is located, where the hangover window includes the initial encoding mode of the current frame and encoding modes of N−1 frames before the current frame, and N is a length of the hangover window; and determine the encoding mode of the current frame based on the initial encoding mode of the current frame and the encoding modes of the N−1 frames.

In some embodiments of this application, the audio encoding apparatus further includes an encoding parameter determining module (not shown in FIG. 12). The encoding parameter determining module is configured to determine, based on the sound field classification result, an encoding parameter corresponding to the current frame.

In some embodiments of this application, the encoding parameter includes at least one of the following: a quantity of channels of a virtual speaker signal, a quantity of channels of a residual signal, a quantity of encoding bits of a virtual speaker signal, a quantity of encoding bits of a residual signal, or a quantity of voting rounds for searching for a best matching speaker.

The virtual speaker signal and the residual signal are signals generated based on the three-dimensional audio signal.

In some embodiments of this application, the quantity of voting rounds meets the following relationship:

1≤I<d

I is the quantity of voting rounds, and d is the quantity of heterogeneous sound sources included in the sound field classification result.

In some embodiments of this application, the sound field classification result includes the quantity of heterogeneous sound sources and the sound field type.

When the sound field type is a heterogeneous sound field, the quantity of channels of the virtual speaker signal meets the following relationship:

F=min(S, PF), where
F is the quantity of channels of the virtual speaker signal, S is the quantity of heterogeneous sound sources, and PF is a quantity of channels of the virtual speaker signal preset by an encoder; or
when the sound field type is a dispersive sound field, the quantity of channels of the virtual speaker signal meets the following relationship:

F=1, where
F is the quantity of channels of the virtual speaker signal.

In some embodiments of this application, when the sound field type is a dispersive sound field, the quantity of channels of the residual signal meets the following relationship:

R=max(C−1, PR), where
PR is a quantity of channels of the residual signal preset by the encoder, and C is a sum of the quantity of channels of the residual signal preset by the encoder and the quantity of channels of the virtual speaker signal preset by the encoder; or
when the sound field type is a heterogeneous sound field, the quantity of channels of the residual signal meets the following relationship:

R=C−F, where
R is the quantity of channels of the residual signal, C is a sum of a quantity of channels of the residual signal preset by the encoder and the quantity of channels of the virtual speaker signal preset by the encoder, and F is the quantity of channels of the virtual speaker signal.

In some embodiments of this application, the sound field classification result includes the quantity of heterogeneous sound sources.

The quantity of channels of the virtual speaker signal meets the following relationship:

F=min(S, PF), where
F is the quantity of channels of the virtual speaker signal, S is the quantity of heterogeneous sound sources, and PF is a quantity of channels of the virtual speaker signal preset by an encoder.

In some embodiments of this application, the quantity of channels of the residual signal meets the following relationship:

R=C−F, where
R is the quantity of channels of the residual signal, C is a sum of a quantity of channels of the residual signal preset by the encoder and the quantity of channels of the virtual speaker signal preset by the encoder, and F is the quantity of channels of the virtual speaker signal.

In some embodiments of this application, the sound field classification result includes the quantity of heterogeneous sound sources, or the sound field classification result includes the quantity of heterogeneous sound sources and the sound field type.

The quantity of encoding bits of the virtual speaker signal is obtained based on a ratio of the quantity of encoding bits of the virtual speaker signal to a quantity of encoding bits of a transmission channel.

The quantity of encoding bits of the residual signal is obtained based on the ratio of the quantity of encoding bits of the virtual speaker signal to the quantity of encoding bits of the transmission channel.

The quantity of encoding bits of the transmission channel includes the quantity of encoding bits of the virtual speaker signal and the quantity of encoding bits of the residual signal, and when the quantity of heterogeneous sound sources is less than or equal to the quantity of channels of the virtual speaker signal, the ratio of the quantity of encoding bits of the virtual speaker signal to the quantity of encoding bits of the transmission channel is obtained by increasing an initial ratio of the quantity of encoding bits of the virtual speaker signal to the quantity of encoding bits of the transmission channel.

In some embodiments of this application, the audio encoding apparatus further includes an encoding module (not shown in FIG. 12). The encoding module is configured to encode the current frame and the sound field classification result, and write the encoded current frame and sound field classification result into a bitstream.

It can be learned from the example in the foregoing embodiment that linear decomposition is first performed on the current frame of the three-dimensional audio signal, to obtain the linear decomposition result. Then, the sound field classification parameter corresponding to the current frame is obtained based on the linear decomposition result. Finally, the sound field classification result of the current frame is determined based on the sound field classification parameter. In this embodiment of this application, linear decomposition is performed on the current frame of the three-dimensional audio signal, to obtain the linear decomposition result of the current frame. Then, the sound field classification parameter corresponding to the current frame is obtained based on the linear decomposition result. Therefore, the sound field classification result of the current frame is determined based on the sound field classification parameter, and sound field classification of the current frame can be implemented based on the sound field classification result. In this embodiment of this application, sound field classification is performed on the three-dimensional audio signal, to accurately identify the three-dimensional audio signal.

FIG. 13 shows a three-dimensional audio signal processing apparatus according to an embodiment of this application. For example, the three-dimensional audio signal processing apparatus is specifically an audio decoding apparatus 1300, and may include a receiving module 1301, a decoding module 1302, and a signal generation module 1303.

The receiving module is configured to receive a bitstream.

The decoding module is configured to decode the bitstream, to obtain a sound field classification result of a current frame.

The signal generation module is configured to obtain a three-dimensional audio signal of the decoded current frame based on the sound field classification result.

In some embodiments of this application, the signal generation module is configured to determine a decoding mode of the current frame based on the sound field classification result, and obtain the three-dimensional audio signal of the decoded current frame based on the decoding mode.

In some embodiments of this application, the signal generation module is configured to: when the sound field classification result includes a quantity of heterogeneous sound sources, or the sound field classification result includes a quantity of heterogeneous sound sources and a sound field type, determine the decoding mode of the current frame based on the quantity of heterogeneous sound sources; when the sound field classification result includes a sound field type, or the sound field classification result includes a quantity of heterogeneous sound sources and a sound field type, determine the decoding mode of the current frame based on the sound field type; or when the sound field classification result includes a quantity of heterogeneous sound sources and a sound field type, determine the decoding mode of the current frame based on the quantity of heterogeneous sound sources and the sound field type.

In some embodiments of this application, the signal generation module is configured to: when the quantity of heterogeneous sound sources meets a preset condition, determine that the decoding mode is a first decoding mode; or when the quantity of heterogeneous sound sources does not meet a preset condition, determine that the decoding mode is a second decoding mode.

The first decoding mode is an HOA decoding mode based on virtual speaker selection or an HOA decoding mode based on directional audio coding, the second decoding mode is an HOA decoding mode based on virtual speaker selection or an HOA decoding mode based on directional audio coding, and the first decoding mode and the second decoding mode are different decoding modes.

In some embodiments of this application, the preset condition includes that the quantity of heterogeneous sound sources is greater than a first threshold or less than a second threshold, and the second threshold is greater than the first threshold; or
the preset condition includes that the quantity of heterogeneous sound sources is not greater than a first threshold or not less than a second threshold, and the second threshold is greater than the first threshold.

In some embodiments of this application, the signal generation module is configured to determine a decoding parameter of the current frame based on the sound field classification result, and obtain the three-dimensional audio signal of the decoded current frame based on the decoding parameter.

In some embodiments of this application, the decoding parameter includes at least one of the following: a quantity of channels of a virtual speaker signal, a quantity of channels of a residual signal, a quantity of decoding bits of a virtual speaker signal, or a quantity of decoding bits of a residual signal.

The virtual speaker signal and the residual signal are obtained by decoding the bitstream.

In some embodiments of this application, the sound field classification result includes the quantity of heterogeneous sound sources and the sound field type.

When the sound field type is a heterogeneous sound field, the quantity of channels of the virtual speaker signal meets the following relationship:

F=min(S, PF), where
F is the quantity of channels of the virtual speaker signal, S is the quantity of heterogeneous sound sources, and PF is a quantity of channels of the virtual speaker signal preset by a decoder; or
when the sound field type is a dispersive sound field, the quantity of channels of the virtual speaker signal meets the following relationship:

F=1, where
F is the quantity of channels of the virtual speaker signal.

In some embodiments of this application, when the sound field type is a dispersive sound field, the quantity of channels of the residual signal meets the following relationship:

R=max(C−1, PR), where
PR is a quantity of channels of the residual signal preset by the decoder, and C is a sum of the quantity of channels of the residual signal preset by the decoder and the quantity of channels of the virtual speaker signal preset by the decoder; or
when the sound field type is a heterogeneous sound field, the quantity of channels of the residual signal meets the following relationship:

R=C−F, where
R is the quantity of channels of the residual signal, C is a sum of a quantity of channels of the residual signal preset by the decoder and the quantity of channels of the virtual speaker signal preset by the decoder, and F is the quantity of channels of the virtual speaker signal.

In some embodiments of this application, the sound field classification result includes the quantity of heterogeneous sound sources.

The quantity of channels of the virtual speaker signal meets the following relation ship:

F=min(S, PF), where
F is the quantity of channels of the virtual speaker signal, S is the quantity of heterogeneous sound sources, and PF is a quantity of channels of the virtual speaker signal preset by a decoder.

In some embodiments of this application, the quantity of channels of the residual signal meets the following relationship:

R=C−F, where
R is the quantity of channels of the residual signal, C is a sum of a quantity of channels of the residual signal preset by the decoder and the quantity of channels of the virtual speaker signal preset by the decoder, and F is the quantity of channels of the virtual speaker signal.

In some embodiments of this application, the sound field classification result includes the quantity of heterogeneous sound sources, or the sound field classification result includes the quantity of heterogeneous sound sources and the sound field type.

The quantity of decoding bits of the virtual speaker signal is obtained based on a ratio of the quantity of decoding bits of the virtual speaker signal to a quantity of decoding bits of a transmission channel.

The quantity of decoding bits of the residual signal is Obtained based on a ratio of the quantity of decoding bits of the virtual speaker signal to the quantity of decoding bits of the transmission channel.

The quantity of decoding bits of the transmission channel includes the quantity of decoding bits of the virtual speaker signal and the quantity of decoding bits of the residual signal, and when the quantity of heterogeneous sound sources is less than or equal to the quantity of channels of the virtual speaker signal, the ratio of the quantity of decoding bits of the virtual speaker signal to the quantity of decoding bits of the transmission channel is obtained by increasing an initial ratio of the quantity of decoding bits of the virtual speaker signal to the quantity of decoding bits of the transmission channel.

It can be learned from the example in the foregoing embodiment that the sound field. classification result can be used to decode the current frame in the bitstream. Therefore, a decoder side performs decoding in a decoding manner matching a sound field of the current frame, to obtain the three-dimensional audio signal sent by an encoder side. This implements transmission of the audio signal from the encoder side to the decoder side.

It should be noted that, content such as information exchange between the modules/units of the apparatus and the execution processes thereof is based on the same idea as the method embodiments of this application, and produces the same technical effect as the method embodiments of this application. For specific content, refer to the foregoing descriptions in the method embodiments of this application. Details are not described herein again.

An embodiment of this application further provides a computer storage medium. The computer storage medium stores a program, and the program performs a part or all of the operations described in the foregoing method embodiments.

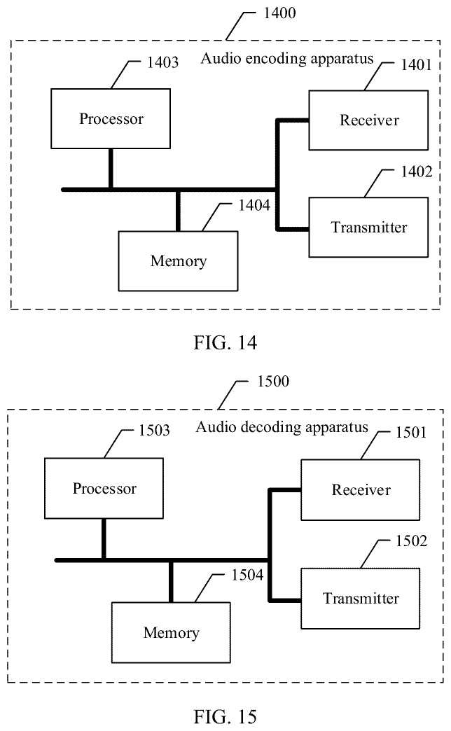

The following describes another audio encoding apparatus according to an embodiment of this application. Refer to FIG. 14. An audio encoding apparatus 1400 includes:
a receiver 1401, a transmitter 1402, a processor 1403, and a memory 1404 (there may be one or more processors 1403 in the audio encoding apparatus 1400, and one processor is used as an example in FIG. 14). In some embodiments of this application, the receiver 1401, the transmitter 1402, the processor 1403, and the memory 1404 may be connected through a bus or in another manner. In FIG. 14, connection through a bus is used as an example.

The memory 1404 may include a read-only memory and a random access memory, and provide instructions and data for the processor 1403. A part of the memory 1404 may further include a non-volatile random access memory (non-volatile random access memory, NVRAM). The memory 1404 stores an operating system and operation instructions, an executable module or a data structure, or a subset thereof, or an extended set thereof. The operation instructions may include various operation instructions used to implement various operations. The operating system may include various system programs, to implement various basic services and process a hardware-based task.

The processor 1403 controls an operation of the audio encoding apparatus, and the processor 1403 may also be referred to as a central processing unit (central processing unit, CPU). During specific application, the components of the audio encoding apparatus are coupled together through a bus system. In addition to a data bus, the bus system may further include a power bus, a control bus, a status signal bus, and the like. However, for clear description, various types of buses in the figure are marked as the bus system.

The method disclosed in embodiments of this application may be applied to the processor 1403, or may be implemented by using the processor 1403. The processor 1403 may be an integrated circuit chip, and has a signal processing capability. In an implementation process, operations in the foregoing methods may be implemented by using a hardware integrated logical circuit in the processor 1403, or by using instructions in a form of software. The processor 1403 may be a general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or transistor logic device, or a discrete hardware component, to implement or perform the methods, the operations, and logical block diagrams that are disclosed in embodiments of this application. The general-purpose processor may be a microprocessor, or the processor may be any conventional processor or the like. Operations of the method disclosed with reference to embodiments of this application may be directly executed and accomplished by using a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory 1404, and the processor 1403 reads information in the memory 1404 and completes the operations in the method in combination with hardware in the processor 1403.

The receiver 1401 may be configured to receive input digital or character information, and generate a signal input related to setting and function control of the audio encoding apparatus. The transmitter 1402 may include a display device such as a display screen, and may be configured to output the digital or character information through an external interface.

In this embodiment of this application, the processor 1403 is configured to perform the method performed by the audio encoding apparatus in the embodiments shown in FIG. 4 to FIG. 6.

The following describes another audio decoding apparatus according to an embodiment of this application. Refer to FIG. 15. An audio decoding apparatus 1500 includes:
a receiver 1501, a transmitter 1502, a processor 1503, and a memory 1504 (there may be one or more processors 1503 in the audio decoding apparatus 1500, and one processor is used as an example in FIG. 15). In some embodiments of this application, the receiver 1501, the transmitter 1502, the processor 1503, and the memory 1504 may be connected through a bus or in another manner. In FIG. 15, connection through a bus is used as an example.

The memory 1504 may include a read-only memory and a random access memory, and provide instructions and data for the processor 1503. A part of the memory 1504 may further include an NVRAM. The memory 1504 stores an operating system and operation instructions, an executable module or a data structure, or a subset thereof, or an extended set thereof. The operation instructions may include various operation instructions used to implement various operations. The operating system may include various system programs, to implement various basic services and process a hardware-based task.

The processor 1503 controls an operation of the audio decoding apparatus, and the processor 1503 may also be referred to as a CPU. During specific application, the components of the audio decoding apparatus are coupled together through a bus system. In addition to a data bus, the bus system may further include a power bus, a control bus, a status signal bus, and the like. However, for clear description, various types of buses in the figure are marked as the bus system.

The method disclosed in embodiments of this application may be applied to the processor 1503, or may be implemented by using the processor 1503. The processor 1503 may be an integrated circuit chip, and has a signal processing capability. In an implementation process, operations in the foregoing methods may be implemented by using a hardware integrated logical circuit in the processor 1503, or by using instructions in a form of software. The foregoing processor 1503 may be a general-purpose processor, a DSP, an ASIC, an FPGA or another programmable logic component, a discrete gate or transistor logic device, or a discrete hardware component, to implement or perform the methods, the operations, and logical block diagrams that are disclosed in embodiments of this application. The general-purpose processor may be a microprocessor, or the processor may be any conventional processor or the like. Operations of the method disclosed with reference to embodiments of this application may be directly executed and accomplished by using a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory 1504, and the processor 1503 reads information in the memory 1504 and completes the operations in the method in combination with hardware in the processor 1503.

In this embodiment of this application, the processor 1503 is configured to perform the method performed by the audio decoding apparatus in the embodiment shown in FIG. 7.

In another possible design, when the audio encoding apparatus or the audio decoding apparatus is a chip in a terminal, the chip includes a processing unit and a communication unit. The processing unit may be, for example, a processor, and the communication unit may be, for example, an input/output interface, a pin, or a circuit. The processing unit may execute computer-executable instructions stored in a storage unit, so that the chip in the terminal performs the audio encoding method in any one of the implementations of the first aspect or the audio decoding method in any one of the implementations of the second aspect. In one embodiment, the storage unit is a storage unit in the chip, for example, a register or a buffer. Alternatively, the storage unit may be a storage unit in the terminal but outside the chip, for example, a read-only memory (ROM), another type of static storage device that can store static information and instructions, or a random access Memory (RAM).

The processor mentioned above may be a general-purpose central processing unit, a microprocessor, an ASIC, or one or more integrated circuits configured to control program execution of the method in the first aspect or the second aspect.

In addition, it should be noted that the apparatus embodiments described above are merely an example. The units described as separate parts may or may not be physically separate, and parts displayed as units may or may not be physical units, may be located in one position, or may be distributed on a plurality of network units. Some or all the modules may be selected based on actual requirements, to achieve the objectives of the solutions of embodiments. In addition, in the accompanying drawings of the apparatus embodiments provided by this application, connection relationships between modules indicate that the modules have communication connections with each other, which may specifically be implemented as one or more communication buses or signal cables.

Based on the descriptions of the foregoing implementations, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, any functions that can be performed by a computer program can be easily implemented by using corresponding hardware. Moreover, a specific hardware structure used to achieve a same function may be in various forms, for example, in a form of an analog circuit, a digital circuit, or a dedicated circuit. However, as for this application, software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (which may be a personal computer, a server, or a network device) to perform the methods described in embodiments of this application.

All or some of the foregoing embodiments may be implemented by using software, hardware, firmware, or any combination thereof. When software is used to implement the embodiments, all or a part of the embodiments may be implemented in a form of a computer program product.

The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state disk, (SSD)), or the like.

1. A three-dimensional audio signal processing method, comprising:
performing a linear decomposition on a current frame of a three-dimensional audio signal, to obtain a linear decomposition result;
obtaining, based on the linear decomposition result, a sound field classification parameter corresponding to the current frame; and
determining a sound field classification result of the current frame based on the sound field classification parameter.

2. The method according to claim 1, wherein the three-dimensional audio signal comprises a higher-order ambisonics (HOA) signal or a first-order ambisonics (FOA) signal.

3. The method according to claim 1, wherein the performing the linear decomposition on the current frame of the three-dimensional audio signal, to obtain the linear decomposition result comprises:
performing a singular value decomposition on the current frame, to obtain a singular value corresponding to the current frame, wherein the linear decomposition result comprises the singular value;
performing a principal component analysis on the current frame, to obtain a first feature value corresponding to the current frame, wherein the linear decomposition result comprises the first feature value; or
performing an independent component analysis on the current frame, to obtain a second feature value corresponding to the current frame, wherein the linear decomposition result comprises the second feature value.

4. The method according to claim 1, wherein there are a plurality of linear decomposition results including the linear decomposition result, and there are a plurality of sound field classification parameters including the sound field classification parameter; and
the obtaining, based on the linear decomposition result, the sound field classification parameter corresponding to the current frame comprises:
obtaining a ratio of an i^{th} linear analysis result of the current frame to an (i+1)^{th} linear analysis result of the current frame, wherein i is a positive integer; and
obtaining, based on the ratio, an i^{th} sound field classification parameter corresponding to the current frame, wherein the sound field classification parameter corresponds to the i^{th} sound field classification parameter.

5. The method according to claim 1, wherein there are a plurality of sound field classification parameters including the sound field classification parameter, and the sound field classification result comprises a sound field type; and
the determining the sound field classification result of the current frame based on the sound field classification parameter comprises:
when values of the plurality of sound field classification parameters all meet a preset dispersive sound source decision condition, determining that the sound field type is a dispersive sound field; or
when at least one of values of the plurality of sound field classification parameters meets a preset heterogeneous sound source decision condition, determining that the sound field type is a heterogeneous sound field.

6. The method according to claim 5, wherein the dispersive sound source decision condition comprises that a value of the sound field classification parameter is less than a preset heterogeneous sound source determining threshold; or
the heterogeneous sound source decision condition comprises that the value of the sound field classification parameter is greater than or equal to a preset heterogeneous sound source determining threshold.

7. The method according to claim 1, wherein there are a plurality of sound field classification parameters including the sound field classification parameter;
the sound field classification result comprises a sound field type, or the sound field classification result comprises a quantity of heterogeneous sound sources and a sound field type; and
the determining the sound field classification result of the current frame based on the sound field classification parameter comprises:
obtaining, based on values of the plurality of sound field classification parameters, the quantity of heterogeneous sound sources corresponding to the current frame; and
determining the sound field type based on the quantity of heterogeneous sound sources corresponding to the current frame.

8. The method according to claim 1, wherein there are a plurality of sound field classification parameters including the sound field classification parameter;
the sound field classification result comprises a quantity of heterogeneous sound sources; and
the determining the sound field classification result of the current frame based on the sound field classification parameter comprises:
obtaining, based on values of the plurality of sound field classification parameters, the quantity of heterogeneous sound sources corresponding to the current frame.

9. The method according to claim 7, wherein the plurality of sound field classification parameters are temp[i], i=0, 1, . . . , min(L, K)−2, L indicates a quantity of channels of the current frame, K is a quantity of signal points corresponding to each channel of the current frame, and min indicates an operation in which a minimum value is selected; and
the obtaining, based on values of the plurality of sound field classification parameters, the quantity of heterogeneous sound sources corresponding to the current frame comprises:
for each of i, from i=0, sequentially performing the-following determining procedures:
determining whether temp[i] is greater than a preset heterogeneous sound source determining threshold; and
when temp[i] is less than the heterogeneous sound source determining threshold in a determining procedure, updating a value of i to i+1, and continuing to perform a next determining procedure; or
when temp[i] is greater than or equal to the heterogeneous sound source determining threshold in the determining procedure, terminating execution of the determining procedure, and determining that i in the determining procedure plus 1 is equal to the quantity of heterogeneous sound sources.

10. The method according to claim 7, wherein the determining the sound field type based on the quantity of heterogeneous sound sources corresponding to the current frame comprises:
when the quantity of heterogeneous sound sources meets a first preset condition, determining that the sound field type is a first sound field type; or
when the quantity of heterogeneous sound sources does not meet a first preset condition, determining that the sound field type is a second sound field type, wherein
the quantity of heterogeneous sound sources corresponding to the first sound field type is different from the quantity of heterogeneous sound sources corresponding to the second sound field type.

11. The method according to claim 10, wherein the first preset condition comprises that the quantity of heterogeneous sound sources is greater than a first threshold and less than a second threshold, and the second threshold is greater than the first threshold; or
the first preset condition comprises that the quantity of heterogeneous sound sources is not greater than the first threshold or not less than the second threshold, and the second threshold is greater than the first threshold.

12. The method according to claim 1, wherein the method further comprises:
determining, based on the sound field classification result, an encoding mode corresponding to the current frame.

13. A three-dimensional audio signal processing method, comprising:
receiving a bitstream;
decoding the bitstream, to obtain a sound field classification result of a current frame; and
obtaining a three-dimensional audio signal of a decoded current frame based on the sound field classification result.

14. The method according to claim 13, wherein the obtaining the three-dimensional audio signal of the decoded current frame based on the sound field classification result comprises:
determining a decoding mode of the current frame based on the sound field classification result; and
obtaining the three-dimensional audio signal of the decoded current frame based on the decoding mode.

15. The method according to claim 14, wherein the determining the decoding mode of the current frame based on the sound field classification result comprises:
when the sound field classification result comprises a quantity of heterogeneous sound sources, or the sound field classification result comprises a quantity of heterogeneous sound sources and a sound field type, determining the decoding mode of the current frame based on the quantity of heterogeneous sound sources;
when the sound field classification result comprises a sound field type, or the sound field classification result comprises a quantity of heterogeneous sound sources and a sound field type, determining the decoding mode of the current frame based on the sound field type; or
when the sound field classification result comprises a quantity of heterogeneous sound sources and a sound field type, determining the decoding mode of the current frame based on the quantity of heterogeneous sound sources and the sound field type.

16. The method according to claim 15, wherein the determining, based on the quantity of heterogeneous sound sources, the decoding mode corresponding to the current frame comprises:
when the quantity of heterogeneous sound sources meets a preset condition, determining that the decoding mode is a first decoding mode; or
when the quantity of heterogeneous sound sources does not meet a preset condition, determining that the decoding mode is a second decoding mode, wherein
the first decoding mode is an HOA decoding mode based on a virtual speaker selection or the HOA decoding mode based on a directional audio coding, the second decoding mode is the HOA decoding mode based on the virtual speaker selection or the HOA decoding mode based on the directional audio coding, and the first decoding mode and the second decoding mode are different decoding modes.

17. The method according to claim 16, wherein the preset condition comprises that the quantity of heterogeneous sound sources is greater than a first threshold and less than a second threshold, and the second threshold is greater than the first threshold; or
the preset condition comprises that the quantity of heterogeneous sound sources is not greater than the first threshold or not less than the second threshold, and the second threshold is greater than the first threshold.

18. A three-dimensional audio signal processing apparatus, wherein the three-dimensional audio signal processing apparatus comprises at least one processor, the at least one processor is coupled to a memory to store instructions, which when executed by the at least one processor, cause the at least one processor:
performing a linear decomposition on a current frame of a three-dimensional audio signal, to obtain a linear decomposition result;
obtaining, based on the linear decomposition result, a sound field classification parameter corresponding to the current frame; and
determining a sound field classification result of the current frame based on the sound field classification parameter.

19. A three-dimensional audio signal processing apparatus, wherein the three-dimensional audio signal processing apparatus comprises at least one processor, the at least one processor is coupled to a memory to store instructions, which when executed by the at least one processor, cause the at least one processor:
receiving a bitstream;
decoding the bitstream, to obtain a sound field classification result of a current frame; and
obtaining a three-dimensional audio signal of the-a decoded current frame based on the sound field classification result.

20. A computer-readable storage medium, comprising the bitstream generated by using the method according to claim 1.
